(19) United States
(12) Patent Application Publication
(10) Pub. No.: US 2026/0220106 A1
(43) Pub. Date: Jul. 30, 2026

(54) STORAGE DEVICE, STORAGE SYSTEM INCLUDING STORAGE DEVICE, AND OPERATION METHOD OF STORAGE DEVICE

(71) Applicant: Samsung Electronics Co., Ltd., Suwon-si (KR)

(72) Inventors: Hyunseung Han, Suwon-si (KR); Soonyoung Kang, Suwon-si (KR); Minuk Kim, Suwon-si (KR); Dong-Min Shin, Suwon-si (KR); Jae Hun Jang, Suwon-si (KR)

(21) Appl. No.: 19/350,328

(22) Filed: Oct. 6, 2025

(30) Foreign Application Priority Data
Jan. 24, 2025 (KR) 10-2025-0011545

(51) Int. Cl. G06F 16/21; G06F 16/22

(52) U.S. Cl. CPC G06F 16/217; G06F 16/2237

(57) ABSTRACT

A storage device includes a memory device that stores a vector database including a plurality of vector data and index information, and a storage controller that controls the memory device. The storage controller receives a query request including a start node identifier from a host device, performs beam search on the start node identifier based on the index information in response to the received query request, and transmits a response including at least one neighbor node identifier corresponding to the start node identifier to the host device.

### CROSS-REFERENCE TO RELATED APPLICATION

This application claims priority under 35 U.S.C. § 119 to Korean Patent Application No. 10-2025-0011545 filed on January 24, 2025, in the Korean Intellectual Property Office, the disclosure of which is incorporated by reference herein in their entireties.

### BACKGROUND

The artificial intelligence (AI) is a field of computer science which may artificially implement various human abilities such as learning, inference, and perception. Nowadays, the artificial intelligence may be used in various fields such as understanding natural languages, translation of natural languages, robotics, artificial vision, problem solving, learning, knowledge acquisition, and cognitive science.

### SUMMARY

In some examples, a large language model (LLM) may be used to perform natural language processing (NLP). A vast amount of data may be used in the LLM, and various data structure algorithms for efficiently managing a vast amount of data may be developed. In some examples, a vector database may be used for managing the data of the LLM. The vector database may provide a quick search through index information.

Implementations according to present disclosure provide a storage device with improved performance, a storage system including the storage device, and an operation method of the storage device.

An aspect of the present disclosure provides a storage device including a memory device that stores a vector database including a plurality of vector data and index information, and a storage controller that controls the memory device. The storage controller receives a query request including a start node identifier from a host device, performs beam search on the start node identifier based on the index information in response to the received query request, and transmits a response including at least one neighbor node identifier corresponding to the start node identifier to the host device.

Another aspect of the present disclosure provides a method of operating a storage device which is configured to store vector database. The method includes receiving a query request including a start node identifier from a host device, selecting neighbor nodes corresponding to the start node identifier by performing beam search on the start node identifier based on index information included in the vector database in response to the query request, and transmitting a response to the query request including neighbor node identifiers corresponding to the neighbor nodes to the host device.

Another aspect of the present disclosure provides a host device that performs an artificial intelligence operation, and a storage device that stores a vector database including a plurality of vector data and index information. The storage device receives a query request including a start node identifier from the host device, performs beam search on the start node identifier based on the index information in response to the received query request, and transmits a response including at least one neighbor node identifier corresponding to the start node identifier to the host device. The host device determines target vector data by performing the artificial intelligence operation based on the at least one neighbor node identifier.

### BRIEF DESCRPTION OF THE DRAWINGS

FIG. 1 is a block diagram illustrating an example of a storage system.

FIG. 2 is a block diagram illustrating an example of storage controller of FIG. 1.

FIG. 3 is a diagram illustrating an example of beam search performed by a beam search circuit of FIG. 2 .

FIG. 4.is a diagram illustrating an example of index information stored in a memory device of FIG. 1.

FIG. 5 is a flowchart illustrating an example operation of a storage system of FIG. 1.

FIG. 6 is a flow chart illustrating an example of a storage system of FIG. 1.

FIGS. 7A-to C are diagrams illustrating an example operation based on the flowchart of FIG. 6 .

FIGS. 8A and 8B are timing diagrams illustrating an operation of a storage system of FIG. 1.

FIG. 9 is a block diagram illustrating an example of a beam search circuit of FIG. 1.

FIG. 10 is a flowchart illustrating an example operation of a storage system of FIG. 1.

FIG. 11 is a diagram for describing an example of an operation S220 of the flowchart of FIG. 10

FIG. 12 is a flowchart illustrating an example operation of a storage system of FIG. 1.

FIG. 13 is a flowchart illustrating an example operation based on the flowhart of FIG. 12.

FIG. 14 is a flowchart illustrating an example operation of a storage system of FIG. 1

FIG. 15 is a diagram for describing an example operation based on the flowchart of FIG. 14.

FIG. 16 is a flowchart illustrating an example of a storage system of FIG. 1

FIG. 17 is a diagram illustrating an example operation based on the flowchart of FIG. 16.

FIG. 18 is a flowchart illustrating an example of a storage system of FIG. 1.

FIG. 19 is a block diagram illustrating an example of a data center to which an example of a storage device is applied.

### DETAILED DESCRPTION

Below, implementations of the present disclosure will be described in detail and clearly to such an extent that an ordinary one in the art easily carries out the present disclosure.

The terms, which are used below, such as “block”, “unit”, and “module” or components corresponding thereto, or functional blocks or circuits in drawings may be implemented in the form of software, hardware, or a combination thereof, which is configured to perform or process various functions, operations, or features described in the detailed description.

Below, when various components are listed by using the conjunction “or”, this may refer to each of the listed components or a combination of at least some of the listed components. For example, “A, B, or C” may refer to A, B, and C respectively or may refer to a combination of A and B, a combination of B and C, a combination of A and C, or a combination of A, B, and C.

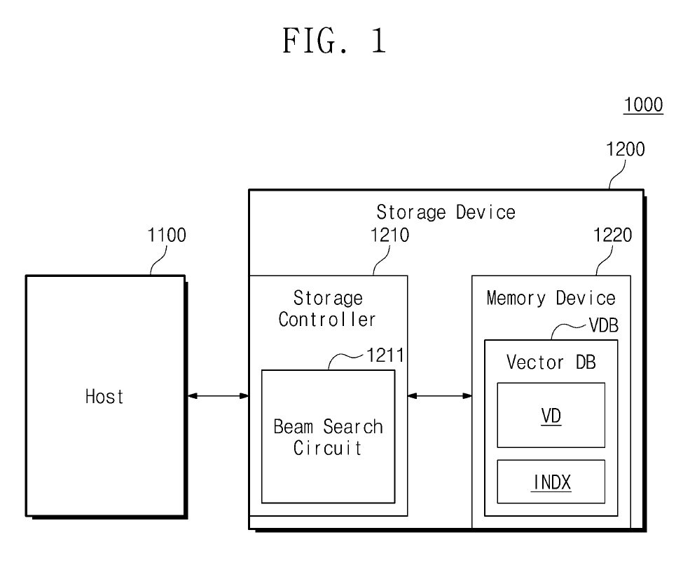

FIG. 1 is a block illustrating a storage system according to some implementations of the present disclosure. Referring to FIG. 1, a storage system 1000 may include a host device 1100 and a storage device 1200. In some implementations, the storage system 1000 may include at least one of various information processing devices such as a personal computer, a laptop computer, a server, a workstation, a smartphone, and a tablet PC. Alternatively, the storage system 1000 may be a data center configured to store and manage various data or may be a storage server or an application server included in the data center. In some implementations, the storage system 1000 may be an automotive electronic system such as a navigation system or an autonomous driving system.

The host device 1100 may control all operations of the storage system 1000. The host device 1100 may communicate with the storage device 1200 through a given interface. In some implementations, the given host interface may include at least one of various interfaces such as an ATA (Advanced Technology Attachment) interface, an SATA (Serial ATA) interface, an e-SATA (external SATA) interface, an SCSI (Small Computer Small Interface) interface, an SAS (Serial Attached SCSI) interface, a PCI (Peripheral Component Interconnection) interface, a PCIe (PCI express) interface, an NVMe (NVM express) interface, an IEEE 1394 interface, an USB (Universal Serial Bus) interface, an SD (Secure Digital) card interface, an MMC (Multi-Media Card) interface, an eMMC (embedded Multi-Media Card) interface, an UFS (Universal Flash Storage) interface, an eUFS (embedded Universal Flash Storage) interface, and a CF (Compact Flash) card interface. Through on a given interface, the host device 1100 may store data in the storage device 1200 or may read data stored in the storage device 1200.

The storage device 1200 may operate under control of the host device 1100. The storage device 1200 may include a storage controller 1210 and a memory device 1220. Under control of the host device 1100 or depending on a request of the host device 1100, the storage controller 1210 may store data in the memory device 1220 or may read data stored in the memory device 1220.

The memory device 1220 may operate under control of the storage controller 1210. In some implementations, the memory device 1230 may include a NAND flash memory device.

In some implementations, the storage system 1000 may be configured to implement or train a large language model (LLM) configured to perform various natural language processing (NLP). For example, the host device 1100 may be an accelerator configured to implement, train, or execute an artificial intelligence model or may include the accelerator. As an example, the accelerator included in the host device 1100 may include a graphics processing unit (GPU), a neural processing unit (NPU), or separate dedicated hardware. Alternatively, the storage system 1000 may be included in an application processor (AP) or may be included in a mobile device.

In some implementations, because a large language model such as an LLM is trained by using a vast amount of data, efficient management for data may be required. To this end, the host device 1100 may manage data necessary to implement, train, or execute the artificial intelligence model by using a vector database VDB. When the host device 1100 implements, trains, or executes the artificial intelligence model based on the vector database VDB, it may be easy to access intended information or data.

In some implementations, the memory device 1220 of the storage device 1200 may store the vector database VDB. The vector database VDB may indicate a data structure which stores or manages information or data necessary for the artificial intelligence model in the form of a vector. The vector database VDB may include vector data VD and index information INDX. The vector data VD may have formats in which various types of data are embedded. The index information INDX may include information about the data structure of the vector data VD included in the vector database VDB. In some implementations, the index information INDX may indicate information for mapping embedded vector data to a given structure by using a hashing, quantization, or graph-based technique.

In some implementations, the host device 1100 may determine a target vector data for input data through the artificial intelligence model. The target vector data may indicate data having high correlation with input data or initial data. When all the vector data and the input data are compared to determine the target vector data, the burden of computation of the host device 1100 increases. To prevent the above issue, the beam search for the vector database VDB may make it easy to search the vector database VDB and determine the target vector data.

In some implementations, the host device 1100 may load the index information INDX to a host memory to search the vector database VDB. However, when the capacity of the vector data VD increases, the capacity of the index information INDX may also increase. In this case, due to the limited capacity of the host memory, the entire index information INDX is incapable of being loaded to the host memory. According to the above description, whenever the search is required, the host device 1100 should read the required index information INDX from the storage device 1200. The iterative read operation on the index information INDX causes the reduction of performance of the artificial intelligence computation (e.g., the delay of the beam search) of the storage system 1000 or the host device 1100.

In some implementations, the storage controller 1210 may include a beam search circuit 1211. The beam search circuit 1211 may perform beam search in response to a query request of the host device 1100. For example, the beam search is a search algorithm which explores a graph by expanding the most promising node in a limited set. For example, the beam search circuit 1211 may receive information about a start node identifier and “k” from the host device 1100. In some implementations, “k” may be a natural number. In this case, the beam search circuit 1211 may read index data corresponding to the start node identifier from the index information INDX of the memory device 1220 and may search for neighbor nodes to a start node. In some implementations, to search for the neighbor nodes may indicate an operation of calculating distances between the start node and the neighbor nodes and selecting nodes having the shortest distance from among the calculated nodes. In some implementations, the index data corresponding to the start node identifier is not transmitted to the host device 1100.

The beam search circuit 1211 may read other index data corresponding to the selected neighbor nodes from the index information INDX of the memory device 1220 and may search for other neighbor nodes based on the other index data thus read. The beam search circuit 1211 may repeatedly perform the above operation and may provide the host device 1100 with node identifiers corresponding to k nodes neighbor to the start node identifier. A structure and an operation of the storage controller 1210 or the beam search circuit 1211 according to some implementations of the present disclosure will be described in detail with reference to the following drawings.

According to the above operation, because the search (e.g., the beam search) for the vector database VDB is performed by the beam search circuit 1211 of the storage controller 1210, the transmission of the index information INDX between the host device 1100 and the storage device 1200 may be omitted. Accordingly, a speed at which the vector database VDB is searched may be improved.

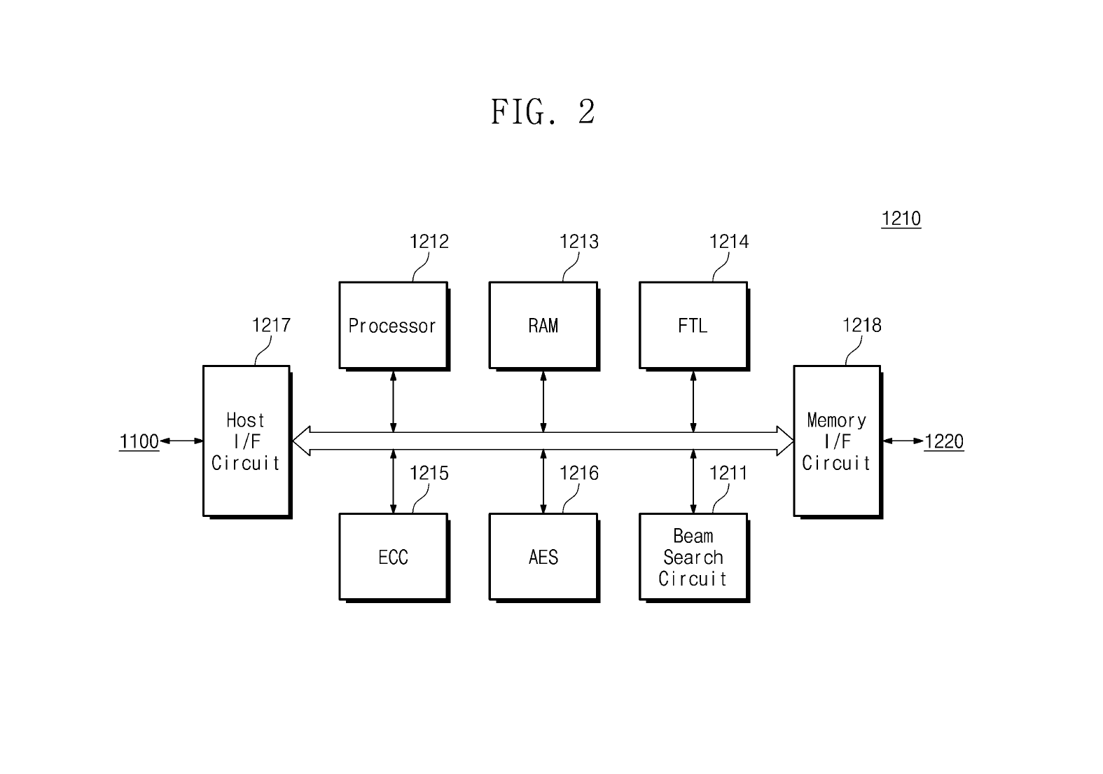

FIG. 2 is a block diagram illustrating a storage controller of FIG. 1. Referring to FIGS. 1 and 2, the storage controller 1210 may include the beam search circuit 1211, a processor 1212, a random access memory (RAM) 1213, a flash translation layer (FTL) 1214, an error correction code (ECC) engine 115, an advanced encryption standard (AES) engine 115, a host device interface circuit 1217, and a memory interface circuit 1218. The beam search circuit 1211 is described above, thus, additional description will be omitted to avoid redundancy. The beam search circuit 1211 will be described in detail with reference to the following drawings.

The processor 1212 may control all operations of the storage controller 1210. For example, the processor 1212 may execute various applications on the controller 1210. The RAM 1213 may be configured to store various information necessary for the storage controller 1210 to operate. In some implementations, the RAM 1210 may be used as a working memory, a cache memory, or a buffer memory of the controller 1210.

The FTL 1214 may perform maintenance operations for efficiently managing or using the memory device 1220. In some implementations, the maintenance operations may include an address mapping operation, a wear-leveling operation, a garbage collection operation, etc.

The address mapping operation of the FTL 1214 may refer to an operation of translating a logical address received from the host device 1100 into a physical address to be used to actually store data in the memory device 1220. In some implementations, the FTL 1214 may perform the address mapping operation by using L2P map data. The wear-leveling operation of the FTL 1214 may refer to an operation of preventing excessive degradation of a specific memory block among the memory blocks included in the memory device 1220. The garbage collection operation of the FTL 1214 may refer to an operation of securing a memory block or a capacity available in the memory devices 1220 by copying valid data of a source memory block to a target memory block and then switching the source memory block into a free block or erasing the source memory block. The FTL 1214 may further perform various management operations such as a bad block management operation, in addition to the above operations. In some implementations, some or all of the functions of the FTL 1214 may be implemented through software, hardware, or a combination thereof.

The ECC engine 1215 may perform an error detection and correction function on data read from the memory device 1220. For example, the ECC engine 1215 may generate parity bits for write data to be written in the memory device 1220, and the parity bits thus generated may be stored in the memory device 1220 together with the write data. When data are read from the memory device 1220, the ECC engine 1215 may correct an error of the read data by using the parity bits read from the memory device 1220 together with the read data and may output the error-corrected read data.

The AES engine 1216 may perform at least one of an encryption operation and a decryption operation on data input to the storage controller 1210 by using a symmetric-key algorithm.

The host device interface circuit 1217 may communicate with the host device 1100 based a host device interface. In some implementations, the host device interface may include at least one of various interfaces such as an ATA (Advanced Technology Attachment) interface, an SATA (Serial ATA) interface, an e-SATA (external SATA) interface, an SCSI (Small Computer Small Interface) interface, an SAS (Serial Attached SCSI) interface, a PCI (Peripheral Component Interconnection) interface, a PCIe (PCI express) interface, an NVMe (NVM express) interface, an IEEE 1394 interface, an USB (Universal Serial Bus) interface, an SD (Secure Digital) card interface, an MMC (Multi-Media Card) interface, an eMMC (embedded Multi-Media Card) interface, an UFS (Universal Flash Storage) interface, an eUFS (embedded Universal Flash Storage) interface, and a CF (Compact Flash) card interface.

The memory interface circuit 1218 may communicate with the memory device 1220 based on a memory interface. In some implementations, the memory interface may include one of interfaces such as a toggle interface or an open NAND flash interface (ONFI).

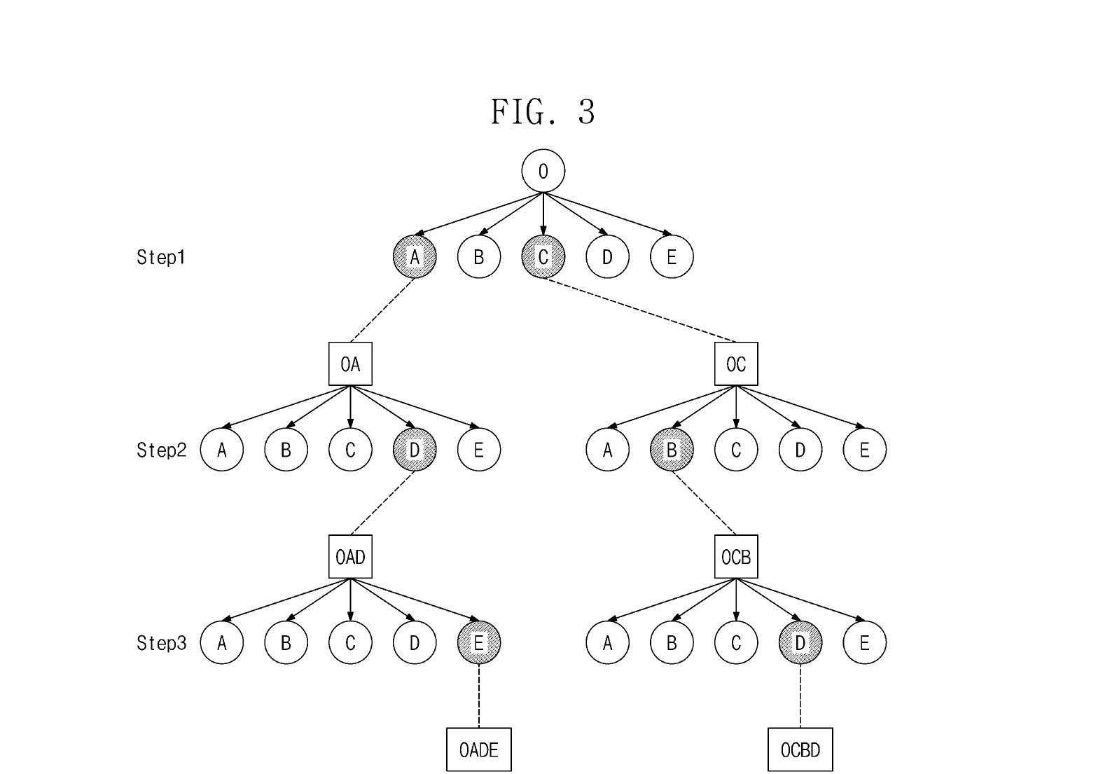

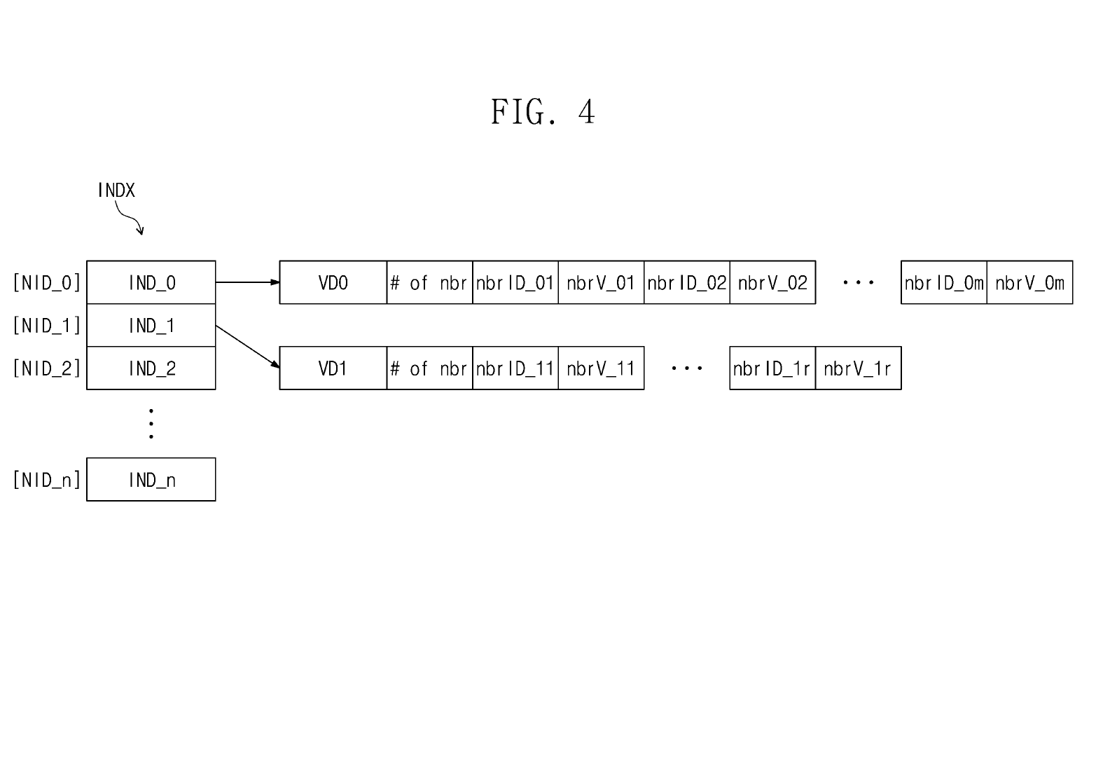

FIG. 3 is a diagram for describing beam search performed by a beam search circuit of FIG. 2. Referring to FIGS. 2 and 3, the beam search circuit 1211 may perform beam search for an input node depending on a request of the host device 1100. For example, as illustrated in FIG. 3, it is assumed that a 0-th node is a start node. In this case, at step 1, nodes adjacent to the 0-th node may be first-searched. For example, a distance of each of nodes A, B, C, D, E adjacent to the 0-th node may be calculated. As an example, the distance may indicate similarity metrics between two nodes. As an example, the similarity metrics may include metrics such as cosine similarity, a Euclidean distance, a dot product.

As an example, nodes the nearest to the 0-th node may be nodes 0A and 0B, and the nodes 0A and 0C may be selected as a candidate node of step 1. Afterwards, at step 2, nodes A, B, C, D, and E adjacent to the nodes 0A and 0C being the candidate nodes may be second-searched. For example, a distance between the node 0A and each of the nodes A, B, C, D, and E adjacent thereto may be calculated, and a distance between the node 0C and each of the nodes A, B, C, D, and E adjacent thereto may be calculated. In this case, the nearest nodes may be nodes 0AD and 0CB, and the nodes 0AD and 0CB may be selected as a candidate node of step 2.

Afterwards, at step 3, nodes A, B, C, D, and E adjacent to the nodes 0AD and 0CB may be third-searched. For example, a distance between the node 0AD and each of the nodes A, B, C, D, and E adjacent thereto may be calculated, and a distance between the node 0CB and each of the nodes A, B, C, D, and E adjacent thereto may be calculated. In this case, the nearest nodes may be nodes 0ADE and 0CBD, and the nodes 0ADE and 0CBD may be selected as a candidate node of step 3. The candidate nodes selected at step 3 may be determined as nodes the nearest to the 0-th node being the start node.

For illustrative purposes, the description is given as step 1 to step 3 may be performed in the beam search. The iterative number of times of each search or each step and the number of candidate nodes selected at each step may be variously changed.

As described above, in the beam search operation, an operation of searching for nodes adjacent to an input node may be repeatedly performed. In some implementations, the search operation may include distance calculation and nearest distance selection. In the implementation of FIG. 3, the search operation is iterated three times. That is, when the beam search is performed by the host device 1100, an operation of reading the index information INDX from the storage device 1200 is iterated at least three times. In contrast, when the beam search is performed by the beam search circuit 1211 of the storage device 1200, the above search operation may be performed without transmitting the index information INDX from the storage device 1200 to the host device 1100.

FIG. 4 is a diagram illustrating index information stored in a memory device of FIG. 1. Referring to FIGS. 1 and 4, the index information INDX may include a plurality of index data IND_0 to IND_n. Each of the plurality of index data IND_0 to IND_n may respectively correspond to a plurality of node identifiers NID_0 to NID_n and may include structure information about a plurality of vector data VD0 to VDn. For example, the 0-th index data IND_0 may correspond to the 0-th node identifier NID_0 and may include structure information about the 0-th vector data VD0 corresponding to the 0-th node identifier NID_0. As an example, the 0-th index data IND_0may include the number of nodes adjacent to the 0-th vector data VD0, denoted as “# of nbr”, a plurality of neighbor node identifiers nbrID_01 to nbrID_0m, and a plurality of neighbor vector values nbrV_01_V to nbrV_0m. The plurality of neighbor node identifiers nbrID_01 to nbrID_0m may indicate identifiers of nodes adjacent to the 0-th vector data VD0. For example, referring to the implementation of FIG. 3, it is assumed that the 0-th vector data VD0 correspond to the 0-th node. In this case, neighbor nodes of the 0-th vector data VD0 may be the nodes A, B, C, D, and E, and the plurality of neighbor node identifiers nbrID_01 to nbrID_0m may be identifiers of the nodes A, B, C, D, and E. The plurality of neighbor vector values nbrV_01 to nbrV_0m may be quantization values of vector data corresponding to the plurality of neighbor node identifiers nbrID_01 to nbrID_0m. For example, the first neighbor vector value nbrV_01 may indicate a quantization value of vector data corresponding to the first neighbor node identifier nbrID_01. The first index data IND_1 may include first vector data VD1, the number of nodes adjacent to the 1-th vector data VD1, denoted as “# of nbr”, a plurality of neighbor node identifiers nbrID_11 to nbrID_1m, and a plurality of neighbor vector values nbrV_11 to nbrV_1m. Each factor is similar to that described above, and thus, additional description will be omitted to avoid redundancy.

In some implementations, it is assumed that distance calculation and nearest distance selection are performed in association with the 0-th node. In this case, the distance calculation may be performed based on the 0-th index data IND_0 corresponding to the 0-th node. For example, a distance between the 0-th node and a node corresponding to the 01-th neighbor node identifier nbrID_01 may be calculated based on the 0-th vector data VD0 and the 01-th neighbor vector value nbrV_01 of the 0-th index data IND_0. Likewise, a distance between the 0-th node and a node corresponding to the 02-th neighbor node identifier nbrID_02 may be calculated based on the 0-th vector data VD0 and the 02-th neighbor vector value nbrV_02 of the 0-th index data IND_0. There may be selected k neighbor nodes having the nearest distance from among the distances obtained through the above calculation. The above operation may be repeatedly performed based on index data corresponding to the selected k neighbor nodes.

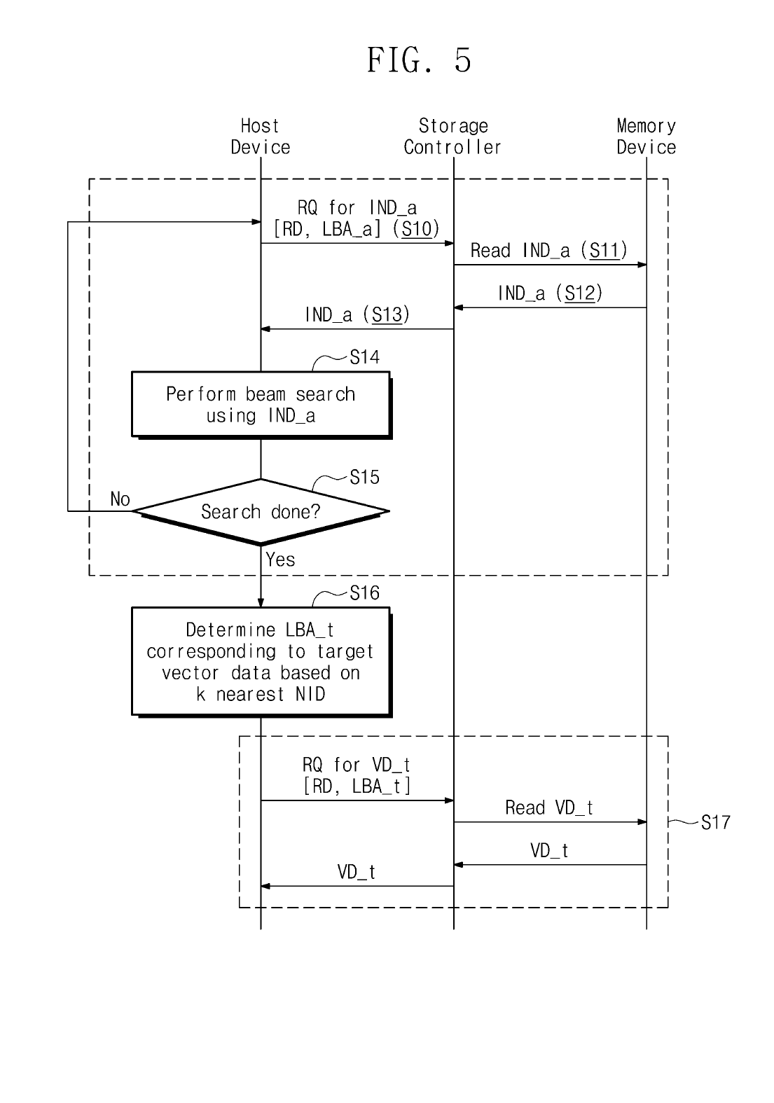

FIG. 5 is a flowchart illustrating an operation of a storage system of FIG. 1. Referring to FIGS. 1 and 5, in operation S10, the host device 1100 may transmit a request for reading an a-th index data IND_a to the storage controller 1210 of the storage device 1200. For example, the host device 1100 may perform distance calculation and nearest distance selection corresponding to an a-th node. To this end, the host device 1100 may require the a-th index data IND_a corresponding to the a-th node. To read the a-th index data IND_a, the host device 1100 may transmit an a-th logical address LAB_a and a read request RD to the storage controller 1210 of the storage device 1200.

In operation S11, the storage controller 1210 may transmit a read command for the a-th index data IND_a to the memory device 1220 in response to the request from the host device 1100. In operation S12, the memory device 1220 may transmit the a-th index data IND_a to the storage controller 1210 in response to the read command. In operation S13, the storage controller 1210 may transmit the a-th index data IND_a to the host device 1100.

In operation S14, the host device 1100 may perform beam search by using the received a-th index data IND_a. For example, the host device 1100 may perform distance calculation and nearest distance selection based on information (e.g., vector values corresponding to neighbor nodes) included in the a-th index data IND_a. The distance calculation and the nearest distance selection are described with reference to FIGS. 3 and 4, and thus, additional description will be omitted to avoid redundancy.

In operation S15, the host device 1100 may determine whether the beam search is done. For example, the host device 1100 may determine whether the distance calculation and the nearest distance selection are performed as much as the given number of times.

When the beam search is not done, the host device 1210, the storage controller 1210, and the memory device 1220 may repeatedly perform operation S10, operation S11, operation S12, operation S13, and operation S14. In this case, the host device 1210, the storage controller 1210, and the memory device 1220 may perform the above operations based on index data corresponding to candidate nodes selected based on the nearest distance in a previous process.

When the beam search is done, in operation S16, the host device 1100 may determine a target logical address LBA_t corresponding to target vector data VD_t based on k nearest distance nodes. For example, the host device 1100 may determine a final target vector data VD_t by performing an artificial intelligence operation based on the k nearest distance nodes..

In operation S17, the host device 1210, the storage controller 1210, and the memory device 1220 may perform the read operation on the target vector data VD_t. For example, to read the target vector data VD_t, the host device 1100 may transmit the read request RD and the target logical address LBA_t to the storage controller 1210. The storage controller 1210 may transmit the read command for reading the target vector data VD_t to the memory device 1220 in response to the read request RD. The memory device 1200 may transmit the target vector data VD_t to the storage controller 1210 in response to the read command. The storage controller 1210 may transmit the target vector data VD_t to the host device 1100.

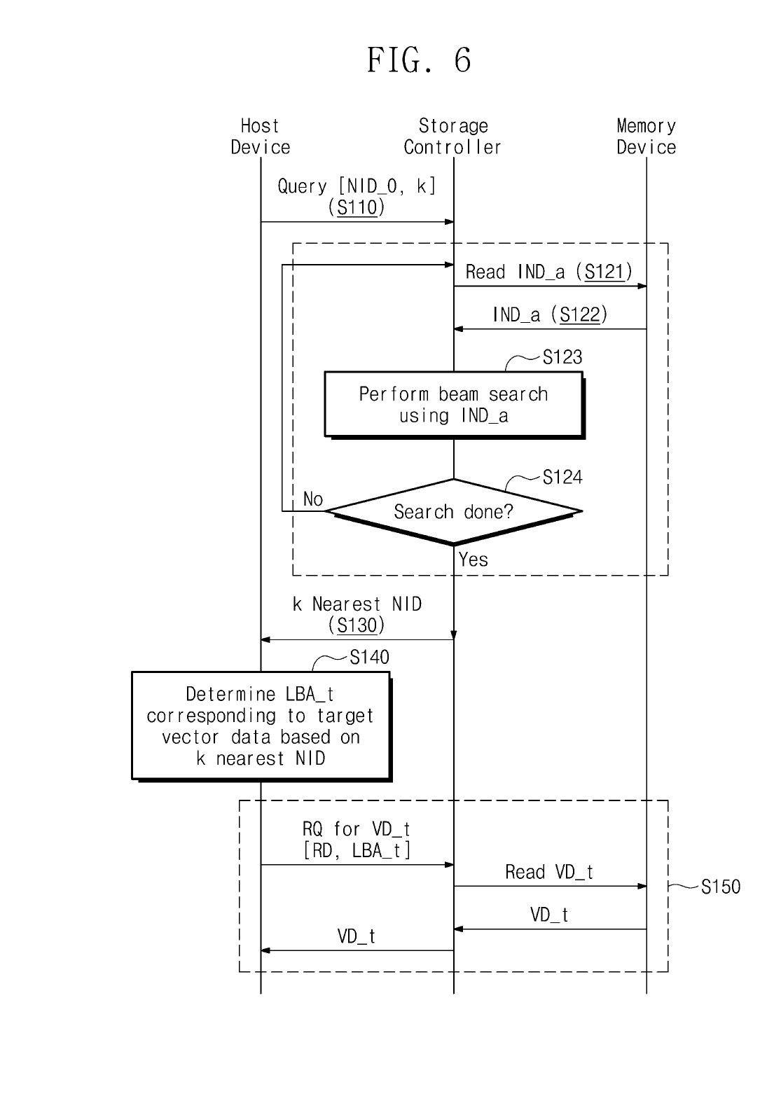

FIG. 6 is a flowchart illustrating a storage system of FIG. 1, according to some implementations of the present disclosure. Referring to FIGS. 1 and 6, in operation S110, the host device 1100 may transmit a query request including information about the 0-th node identifier NID_0 and “k” to the storage controller 1210. In some implementations, the host device 1100 may transmit the query request including vector data, not a node identifier. In some implementations, the “k” may indicate the number of nearest distance nodes which the host device 1100 wants to obtain as a search result.

For example, the host device 1100 may transmit, to the storage controller 1210, the query request for obtaining information about k nodes the nearest to the 0-th node identifier NID_0. In some implementations, the query request may be defined by the interface between the host device 1100 and the storage device 1200. Alternatively, the query request may be a user request or a vendor request specified by the interface between the host device 1100 and the storage device 1200.

In operation S121, the storage controller 1210 may transmit the read command for reading the a-th index data IND_a to the memory device 1220. In some implementations, the a-th index data IND_a may correspond to the 0-th node identifier NID_0. In operation S122, the memory device 1220 may transmit the a-th index data IND_a to the storage controller 1210.

In operation S123, the storage controller 1210 may perform beam search (e.g., may search for neighbor nodes) by using the a-th index data IND_a. For example, the a-th index data IND_a may include vector data corresponding to the 0-th node identifier NID_0, identifiers of neighbor nodes, and vector values. The beam search circuit 1211 of the storage controller 1210 may select the nearest distance by calculating distances between the 0-th node and the neighbor nodes by using information of the a-th index data IND_a.

In operation S124, the storage controller 1210 may determine whether the beam search is done. For example, the storage controller 1210 may determine whether the distance calculation and the nearest distance selection are iterated as much as the given number of times.

When the beam search is not done, the storage controller 1210 and the memory device 1220 may perform operation S121. In some implementations, in this case, the storage controller 1210 may perform the distance calculation and the nearest distance selection based on index data corresponding to candidate nodes determined by the binary beam search. For example, when a 01-th neighbor node is selected as a candidate node, the storage controller 1210 may read 01-th index data corresponding to the 01-th neighbor node from the memory device 1220 and may perform beam search based on the 01-th index data.

When the beam search is done, in operation S130, the storage controller 1210 may transmit neighbor node identifiers NID corresponding to k nearest nodes to the host device 1100. For example, through operation S121 to operation S124, the storage controller 1210 may perform beam search on the 0-th node identifier NID_0. That is, the storage controller 1210 may obtain information about the k node identifiers NID near to the 0-th node identifier NID_0. The information about the k node identifiers NID may be transmitted from the storage controller 1210 to the host device 1100 as a response to the query request in operation S110.

In operation S140, the host device 1100 may determine the target logical address LBA_t corresponding to the target vector data VD_t based on the k node identifiers NID. In operation S150, the host device 1210, the storage controller 1210, and the memory device 1220 may perform the read operation on the target vector data VD_t. Operation S140 and operation S150 are similar to operation S16 and operation S17 of FIG. 5, and thus, additional description will be omitted to avoid redundancy.

As described above, according to some implementations of the present disclosure, the storage controller 1210 may obtain node identifiers of k nodes near to an input node by performing beam search on the input node or a start node in response to the query request of the host device 1100. In this case, because an operation of transmitting/receiving index data to/from the host device 1100 is not performed, a beam search speed may be improved.

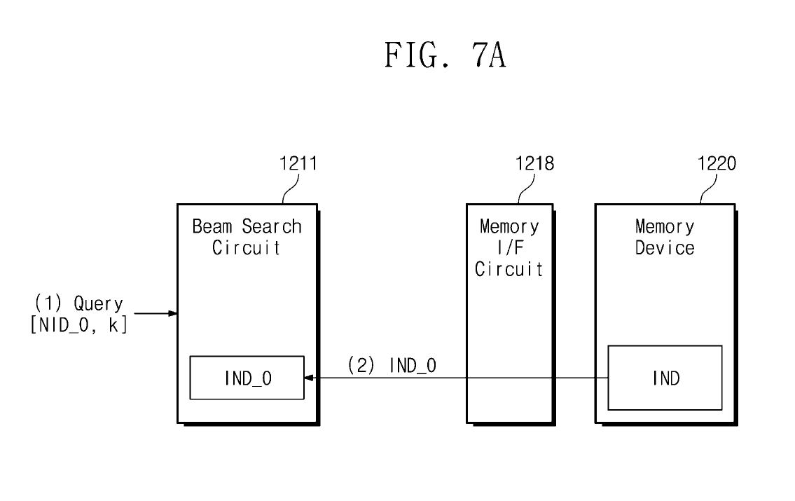

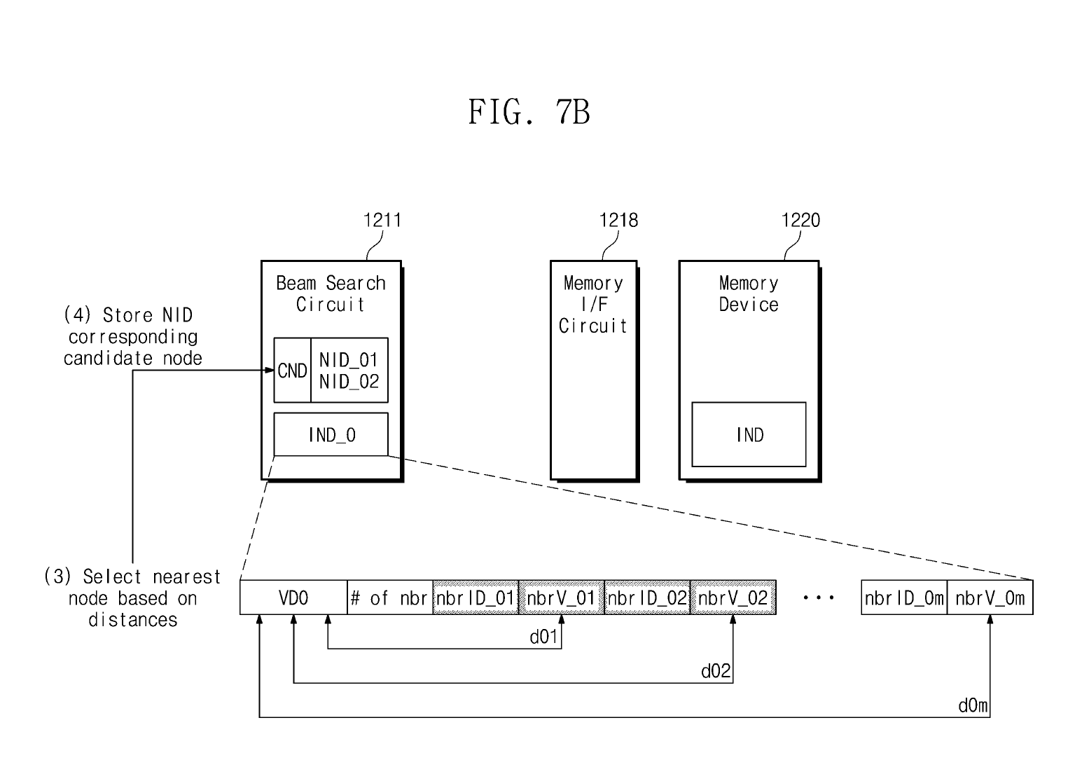

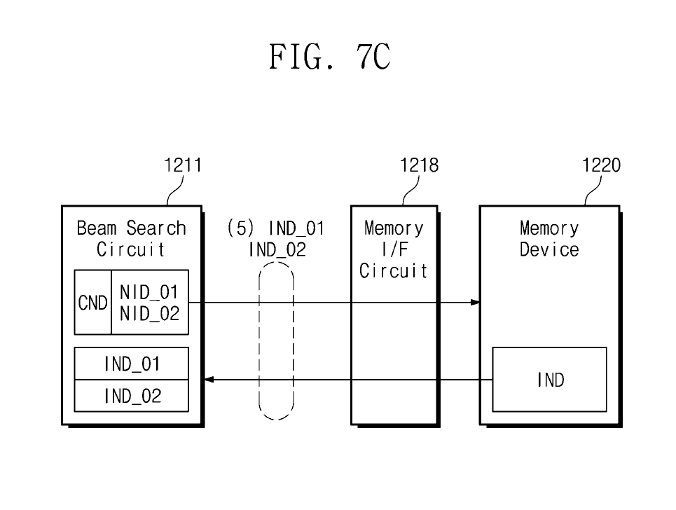

FIGS. 7A to 7C are diagrams for describing an operation based on the flowchart of FIG. 6, according to some implementations of the present disclosure. For convenience of description, components which are unnecessary to describe the beam search operation performed by the beam search circuit 1211 of the storage controller 1210 are omitted.

Referring to FIGS. 1, 7A, 7B, and 7C, in operation (1) of FIG. 7A, the beam search circuit 1211 may receive the query request from the host device 1100. The query request may include information requesting k node identifiers near to the 0-th node identifier NID_0.

In operation (2) of FIG. 7A, the beam search circuit 1211 may read the 0-th index data IND_0 corresponding to the 0-th node identifier NID_0 from the memory device 1220 in response to the query request. For example, the memory device 1220 may store the index information INDX including a plurality of index data. The beam search circuit 1211 may read the 0-th index data IND_0 corresponding to the 0-th node identifier NID_0 from among the plurality of index data included in the index information INDX from the memory device 1220 through the memory interface circuit 1218.

In operation (3) of FIG. 7B, the beam search circuit 1211 may calculate distances between respective nodes by using the 0-th index data IND_0 and may select the nearest nodes (i.e., may search for neighbor nodes). For example, as illustrated in FIG. 7B, the 0-th index data IND_0 may include the 0-th vector data VD0 corresponding to the 0-th node identifier NID_0, the number of neighbor nodes, denoted as “# of nbr”, the plurality of neighbor node identifiers nbrID_01 to nbrID_0m, and the plurality of neighbor vector values nbrV_01 to nbrV_0m.

The beam search circuit 1211 may calculate a 01-th distance d01 based on the 0-th vector data VD0 and the 01-th near vector value nbrV_01. The 01-th distance d01 may indicate a distance (e.g., cosine similarity, a Euclidean distance, or a dot product) between a node corresponding to the 0-th node identifier NID_0 and a node corresponding to the 01-th neighbor node identifier nbrID_01. Likewise, the beam search circuit 1211 may calculate a 02-th distance d02 based on the 0-th vector data VD0 and the 02-th neighbor vector value nbrV_02. The beam search circuit 1211 may calculate a 0m-th distance d0m based on the 0-th vector data VD0 and the 0m-th neighbor vector value nbrV_0m. That is, the beam search circuit 1211 may calculate distances d01 to d0m from the 0-th vector data VD0 to the respective neighbor vector values nbrV_01 to nbrV_0m included in the 0-th index data IND_0.

The beam search circuit 1211 may select k candidate nodes having the nearest distance from among the calculated distances d01 to d0m. For example, the 01-th and 02-th distances d01 and d02 among the calculated distances d01 to d0m may be the nearest distances (i.e., the nearest distance and the second nearest distance). In this case, the beam search circuit 1211 may select the 01-th neighbor node identifier nbrID_01 and the 02-th neighbor node identifier nbrID_02 corresponding to the 01-th and 02-th distances d01 and d02 as a candidate node.

In operation (4) of FIG. 7B, the beam search circuit 1211 may store the selected neighbor node identifiers as candidate nodes CND. For example, through the distance calculation and the nearest distance selection described above, the 01-th neighbor node identifier nbrID_01 and the 02-th neighbor node identifier nbrID_02 may be selected. In this case, the beam search circuit 1211 may store the 01-th node identifier NID_01 corresponding to the 01-th neighbor node identifier nbrID_01 and the 02-th node identifier NID_02 corresponding to the 02-th neighbor node identifier nbrID_02 as the candidate node CND. In some implementations, the candidate node CND may be used as an input node for distance calculation and nearest distance selection to be performed later. In operation (5) of FIG. 7C, the beam search circuit 1211 may read pieces of index data corresponding to the candidate node CND from the index information INDX of the memory device 1220. For example, as described above, the candidate nodes CND may include information about the 01-th node identifier NID_01 and the 02-th node identifier NID_02. In this case, the beam search circuit 1211 may read the 01-th index data IND_01 corresponding to the 01-th node identifier NID_01 and the 02-th index data IND_02 corresponding to the 02-th node identifier NID_02 from the memory device 1220.

In some implementations, the 01-th index data IND_01 may include vector data corresponding to the 01-th node identifier NID_01, the number of neighbor nodes, a neighbor node identifier, and a neighbor node vector value, and the 02-th index data IND_02 may include vector data corresponding to the 02-th node identifier NID_02, the number of neighbor nodes, a neighbor node identifier, and a neighbor node vector value.

In some implementations, the beam search circuit 1211 may select k candidate nodes having the nearest distance by performing distance calculation and nearest distance selection based on the 01-th index data IND_01 and 02-th index data IND_02. In some implementations, as the distance calculation and the nearest distance selection are repeatedly performed, the number of selected neighbor nodes may be variously changed.

In some implementations, the beam search circuit 1211 may select k neighbor nodes by repeatedly performing the above operation.

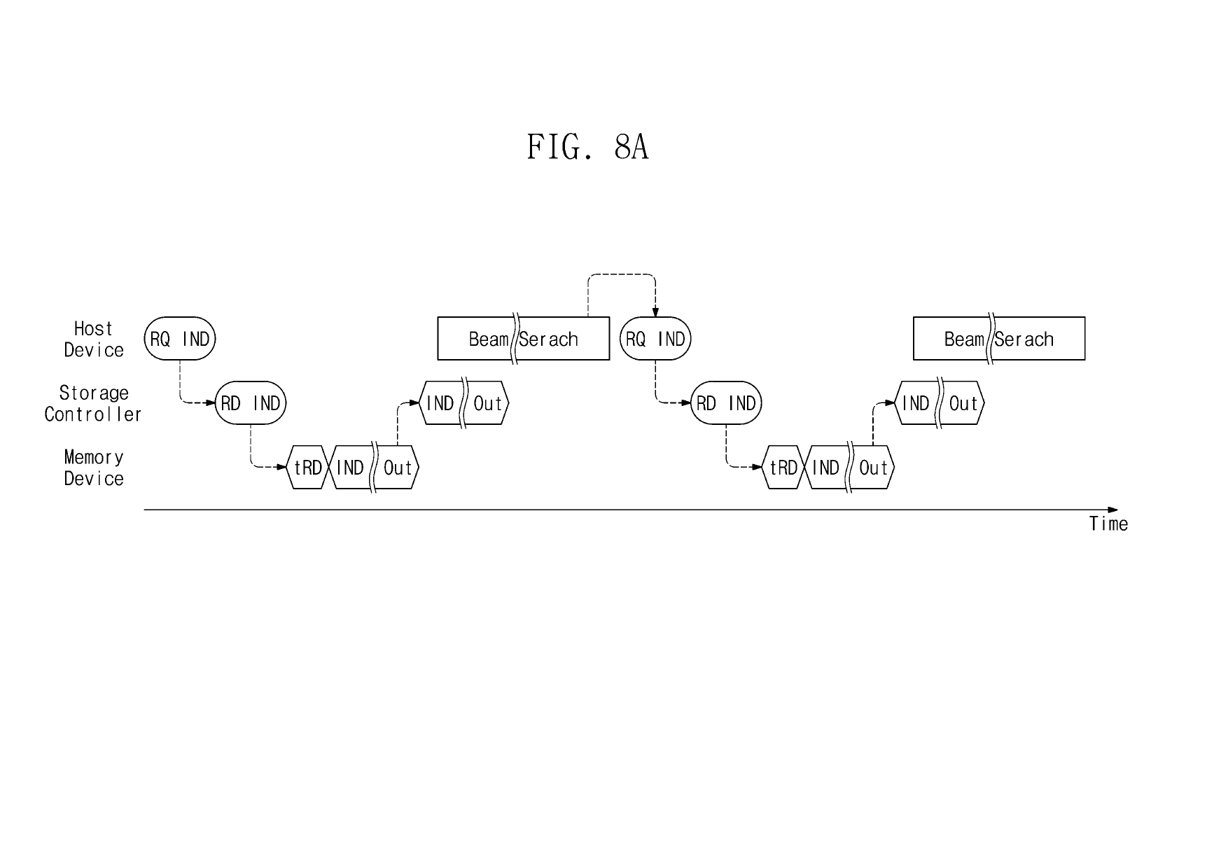

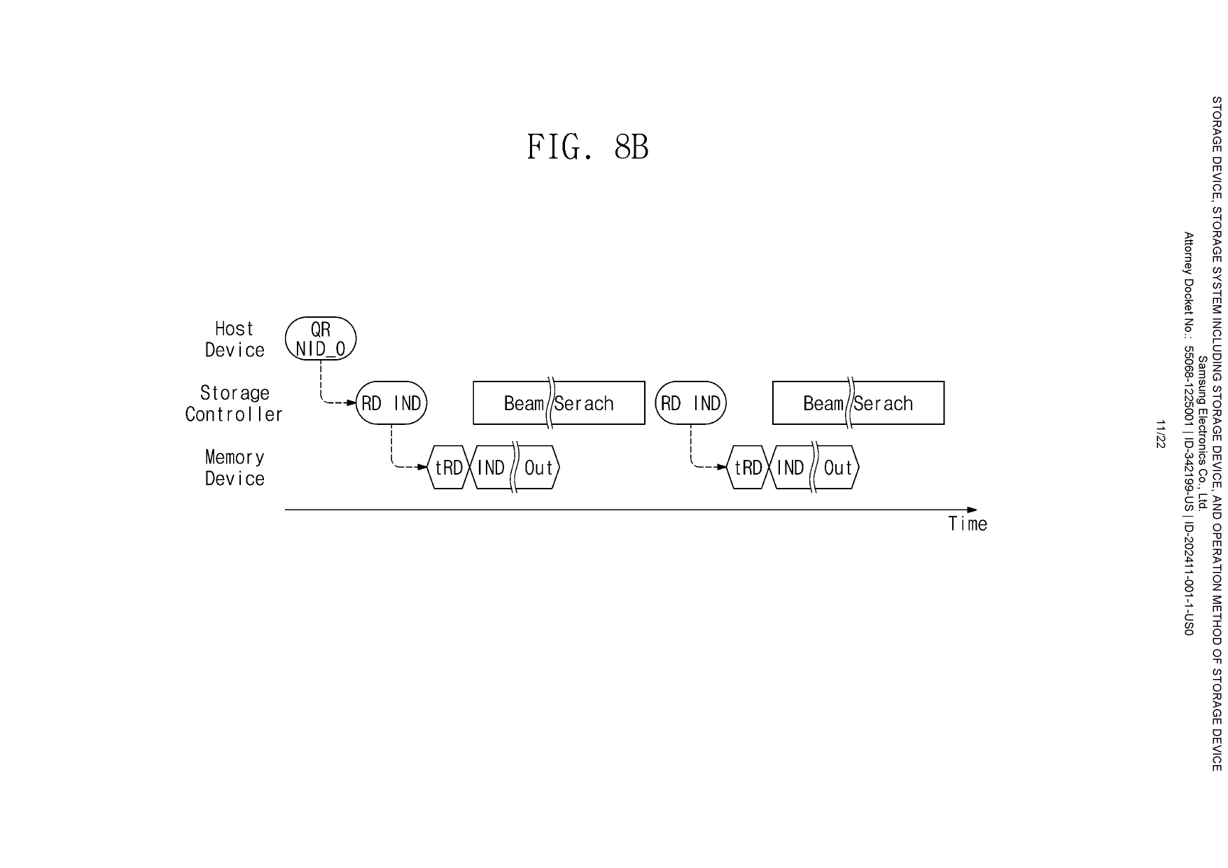

FIGS. 8A and 8B are timing diagrams illustrating an operation of a storage system of FIG. 1, according to some implementations of the present disclosure. For convenience of description, a data input/output or an operation of the host device 1100, the storage controller 1210, and the memory device 1220 is briefly expressed with reference to FIGS. 8A and 8B. An operation based on the flowchart of FIG. 5 will be described with reference to FIG. 8A, and an operation based on the flowchart of FIG. 6 will be described with reference to FIG. 8B.

First, referring to FIGS. 1, 5, and 8A, for the beam search operation, the host device 1100 may request the index data IND from the storage controller 1210 (refer to “RQ IND” in FIG. 8A). In response to the request, the storage controller 1210 may transmit a read command RD IND for reading the requested index data IND to the memory device 1220. The memory device 1220 may perform the read operation during a read time tRD in response to the read command RD IND. After the read operation, the memory device 1220 may transmit the index data IND to the storage controller 1210 (refer to “IND out” in FIG. 8A). The storage controller 1210 may receive the index data IND from the memory device 1220 and may transfer the received index data IND to the host device 1100. The host device 1100 may receive the index data IND and may perform beam search (e.g., neighbor node search or distance calculation and nearest distance selection) based on the received index data IND.

Afterwards, the host device 1100 may request the index data IND corresponding to candidate nodes from the storage controller 1210. The following operation is similar to that described above, and thus, additional description will be omitted to avoid redundancy.

Next, referring to FIGS. 1, 6, and 8B, the host device 1100 may transmit a query request for the 0-th node identifier NID_0 to the storage controller 1210. For example, the host device 1100 may require k nodes near to a node corresponding to the 0-th node identifier NID_0. In this case, the host device 1100 may transmit the query request for the 0-th node identifier NID_0 to the storage controller 1210.

In response to the query request, the storage controller 1210 may provide the memory device 1220 with the read command RD IND for reading the index data IND from the memory device 1220. The memory device 1220 may perform the read operation during a read time tRD in response to the read command RD IND. After the read operation, the memory device 1220 may transmit the index data IND to the storage controller 1210 (refer to “IND out” in FIG. 8B).

The storage controller 1210 may receive the index data IND from the memory device 1220 and may perform beam search (e.g., neighbor node search or distance calculation and nearest distance selection) by using the received index data IND. Afterwards, the storage controller 1220 may transmit the read command RD IND for reading the index data IND corresponding to the candidate nodes to the memory device 1220. The following operation is similar to that described above, and thus, additional description will be omitted to avoid redundancy.

According to the timing diagram of FIG. 8A, beam search is performed by the host device 1100. In this case, for one beam search, there is required an operation in which the index data IND are transmitted from the storage controller 1210 to the host device 1100. In contrast, according to the timing diagram of FIG. 8B, beam search is performed by storage controller 1210. In this case, for one beam search, there is not required an operation in which the index data IND are transmitted from the storage controller 1210 to the host device 1100. That is, because the operation of transmitting the index data IND from the storage controller 1210 to the host device 1100 is not performed, an operation time according to the transmission operation may be shortened. Accordingly, the entire time for beam search may be shortened. This means that the performance of the storage system 1000 is improved.

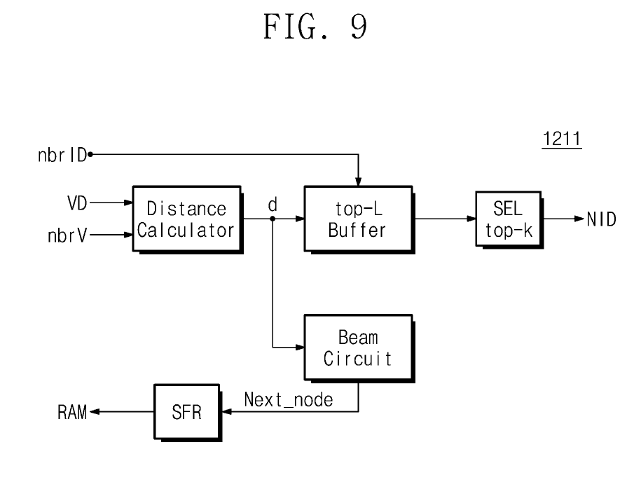

FIG. 9 is a block diagram illustrating a beam search circuit of FIG. 1, according to implementation of the present disclosure. Referring to FIGS. 1, 4, and 9, the beam search circuit 1211 may perform distance calculation and nearest distance selection based on the index data IND and may output node identifiers of k neighbor nodes.

For example, the beam search circuit 1211 may include a distance calculator, a top-L buffer, a beam circuit, a special function register (SFR), and a top-k selector (SEL top-k).

The distance calculator may calculate a distance d based on the vector data VD included in the index data IND and a vector value nbrV of a neighbor node. The calculated distance d may be transferred to the top-L buffer and the beam circuit. The top-L buffer may compare the calculate distance d and a stored distance and may store neighbor node identifiers nbrID corresponding to L top nearest distances.

The beam circuit may output a calculation signal Next_node for a next node based on the calculated distance d. The calculation signal Next_node for the next node is stored in the special function register. The information stored in the special function register may be provided to an RAM (e.g., refer to 1213 of FIG. 2), and the RAM 1213 may provide a neighbor node vector value corresponding to a next neighbor node to the distance calculator in response to the information stored in the special function register. After the above operation is iterated, the top-k selector may output neighbor node identifiers corresponding to k top nearest distances as the nearest distance node identifier NID.

The beam search circuit 1211 of FIG. 9 is provided as an example. The beam search circuit 1211 may be implemented in the storage controller 1210 through various forms, for example, software, hardware, firmware, or a combination of at least two thereof.

As described above, according to implementations of the present disclosure, the storage controller 1210 of the storage device 1200 may receive the query request for searching for k nodes near to the input node from the host device 1100. In response to the query request, the storage controller 1210 may repeatedly perform beam search by using index data corresponding to the input node and may transmit node identifiers NID of the k nodes to the host device 1100. In this case, because the index data IND used for beam search are not transmitted to the host device 1100, an operation time according to the transmission/reception of the index data IND may be shortened. In some examples, while the storage device 1200 performs the beam search, the index information is not transmitted to the host device.

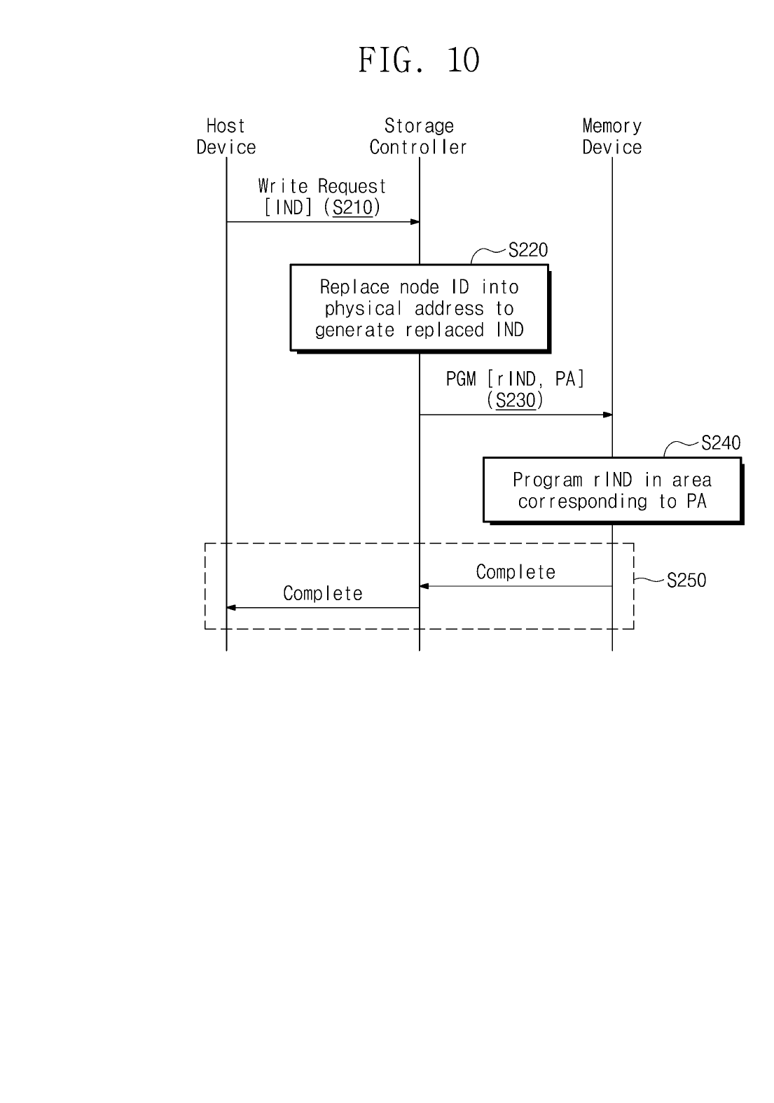

FIG. 10 is a flowchart illustrating an example operation of a storage system of FIG. 1, according to some implementations of the present disclosure. Referring to FIGS. 1 and 10, in operation S210, the host device 1100 may transmit, to the storage device 1200, a write request for storing the index data IND in the storage device 1200. For example, the vector database VDB stored in the storage device 1200 may be managed by the host device 1100. For example, the vector data VD included in the vector database VDB may be embedded or structured by the host device 1100, and thus, the index information INDX may be generated or managed by the host device 1100. That is, when the index information INDX or the index data IND are generated or updated, the index information INDX or the index data IND may be stored in the storage device 1200 by the host device 1100.

In operation S220, the storage controller 1210 may generate replaced index data rIND by replacing a neighbor node identifier (e.g., nbrID) included in the index data IND with a physical address.

In operation S230, the storage controller 1210 may transmit a program command PGM for programming the replaced index data rIND in an area corresponding to a physical address PA to the memory device 1220. In some implementations, the physical address PA at which the replaced index data rIND are stored may correspond to a node identifier of the replaced index data rIND.

In operation S240, the memory device 1220 may store the replaced index data rIND in the area corresponding to the physical address PA.

In operation S250, the storage controller 1210 may receive information about program completion from the memory device 1220 and may transmit the information about program completion to the host device 1100,

In some implementations, a conventional storage device may perform address translation between a logical address and a physical address by using L2P mapping. That is, during the beam search operation of the storage controller 1210, when the read operation on a plurality of index data IND is repeatedly performed, physical addresses at which the plurality of index data IND are stored are identified through the FTL 1214. In this case, the address translation operation of the FTL 1214 may cause a time delay.

In contrast, according to the above implementation, the beam search circuit 1211 of the storage controller 1210 may perform beam search without passing through the FTL 1214. For example, the replaced index data rIND includes information about the physical address PA, instead of the neighbor node identifier nbrID. In this case, the physical address PA may indicate a physical location at which replaced index data corresponding to the neighbor node identifier nbrID are stored. In detail, it is assumed that the 0-th index data IND_0 includes the 01-th neighbor node identifier nbrID_01 and the 01-th neighbor vector value nbrV_01. In this case, the 01-th neighbor node identifier nbrID_01 may be replaced with a 01-th physical address PA01. That is, a 0-th replaced index data rIND_0 may include the 01-th physical address PA01 and the 01-th neighbor node vector value nbrV_01. In this case, replaced index data (e.g., rIND_0) corresponding to the 01-th neighbor node identifier nbrID_01 are stored in an area of the memory device 1220, which corresponds to the 01-th physical address PA01.

In this case, when the 01-th neighbor node vector value nbrV_01 is selected by the beam search circuit 1211 as corresponding to the nearest distance, the beam search circuit 1211 may read replaced index data (e.g., rIND_0), which correspond to the 01-th neighbor node identifier nbrID_01 stored at the 01-th physical address PA01, by using the 01-th physical address PA01 of the 0-th replaced index data rIND_0 and may continuously perform beam search based on the replaced index data (e.g., rIND_0). That is, because a physical address of replaced index data necessary for next beam search is checked based on the physical address at which the replaced index data rIND are stored, there is no need to pass through the FTL 1214 during the beam search operation.

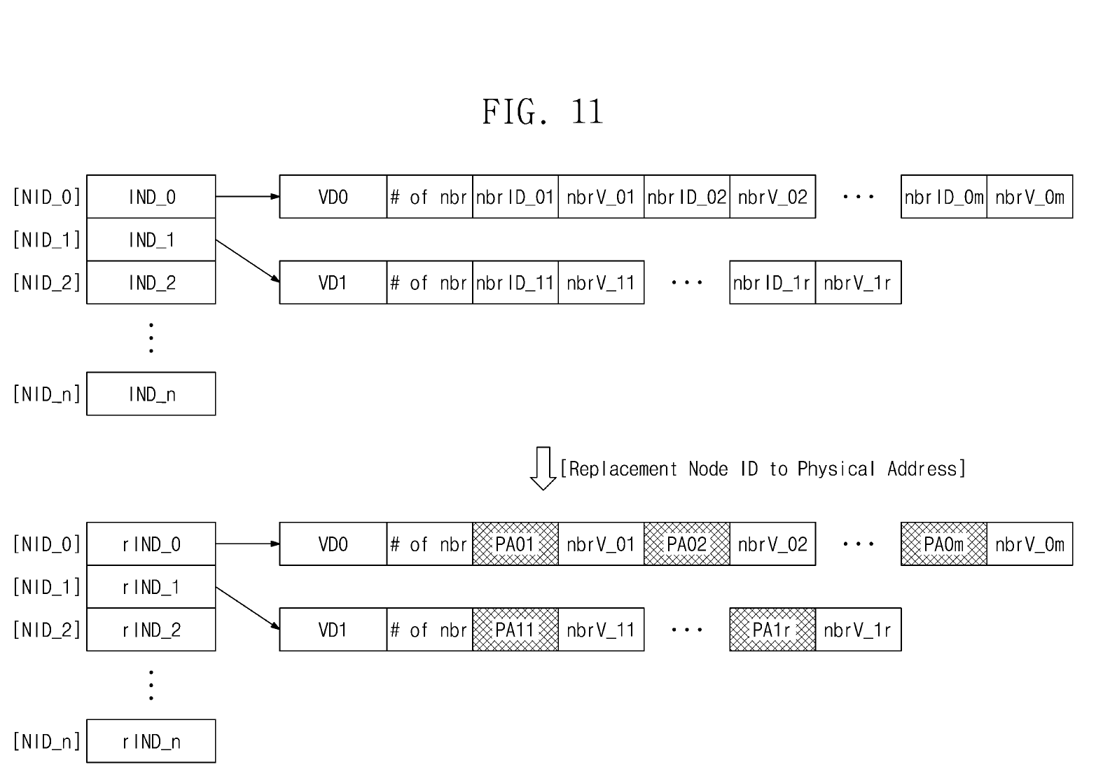

FIG. 11 is a diagram for describing operation S220 of the flowchart of FIG. 10, according to some implementations of the present disclosure. Referring to FIGS. 1, 10, and 11, the host device 1100 may store the plurality of index data IND_0 to IND_n in the memory device 1220 of the storage device 1200.

In this case, the storage controller 1210 may generate replaced index data rIND_0 to rIND_n by replacing neighbor node identifiers nbrID_01 to nbrID_0m, nbrID_11 to nbrID_1r, etc. included in the plurality of index data IND_0 to IND_n with a plurality of physical addresses PA01 to PA0m, PA11 to PA1r, etc. The replaced index data rIND_0 to rIND_n may be stored in an area of the memory device 1220, which corresponds to a physical address.

For example, the 0-th index data IND_0 corresponding to the 0-th node identifier NID_0 may include the 0-th vector data VD0 corresponding to the 0-th node identifier NID_0, the number of neighbor nodes, denoted as “# of nbr”, the plurality of neighbor node identifiers nbrID_01 to nbrID_0m, and the plurality of neighbor node vector values nbrV_01 to nbrV_0m. The storage controller 1210 may generate the 0-th replaced index data rIND_0 by replacing the plurality of neighbor node identifiers nbrID_01 to nbrID_0m of the 0-th index data IND_0 with the plurality of physical addresses PA01 to PA0m. The 0-th replaced index data rIND_0 may be stored in an area of the memory device 1220, which corresponds to the 0-th physical address PA0. In some implementations, the 0-th physical address PA0 may be determined by replacing the 0-th node identifier NID_0.

In some implementations, the plurality of physical addresses PA01 to PA0m of the 0-th replaced index data rIND_0 may indicate locations at which replaced index data of neighbor nodes are respectively stored. For example, in the 0-th replaced index data rIND_0, the 01-th neighbor node identifier nbrID_01 is replaced with the 01-th physical address PA01. This means that replaced index data corresponding to the 01-th neighbor node identifier nbrID_01 are stored at the 01-th physical address PA01. That is, when it is determined that the 01-th neighbor vector value nbrV_01 corresponds to the nearest distance, the storage controller 1210 or the beam search circuit 1211 may read the replaced index data corresponding to the 01-th neighbor node identifier nbrID_01 from the memory device 1220 through the read operation on the 01-th physical address PA01 without passing through the FTL 1214.

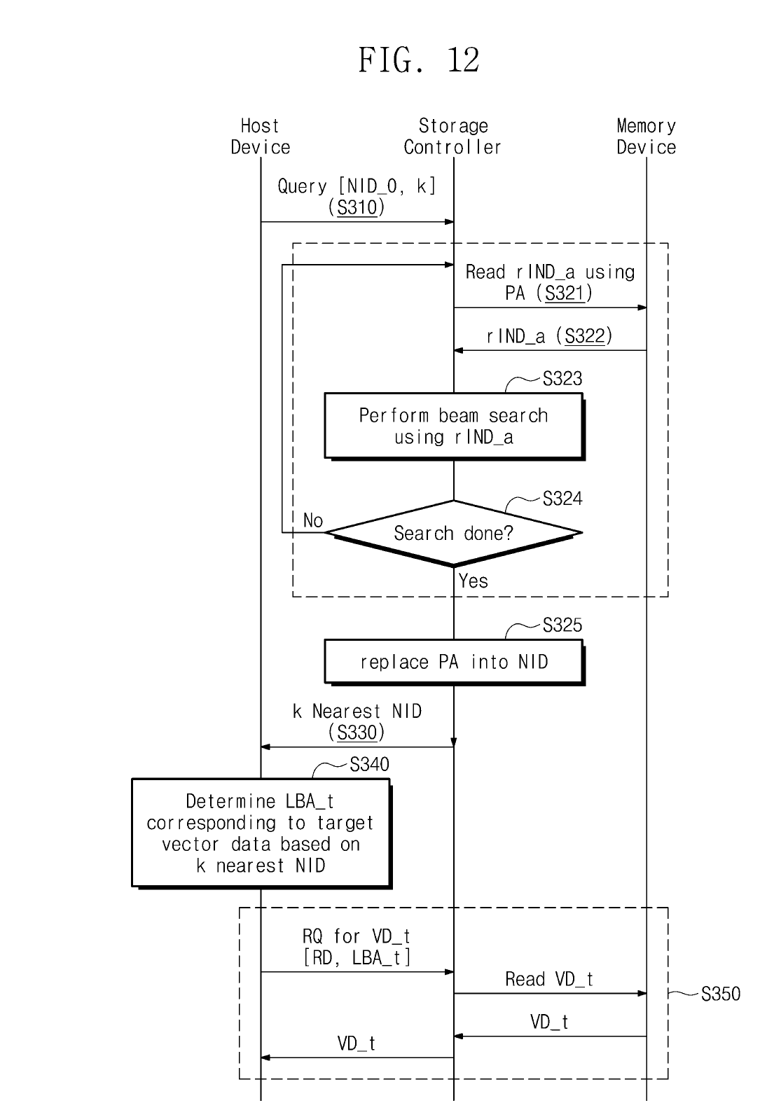

FIG. 12 is a flowchart illustrating an operation of a storage system of FIG. 1, according to some implementations of the present disclosure. For convenience of description, additional description associated with the components described above will be omitted to avoid redundancy. Referring to FIGS. 1 and 12, in operation S310, the host device 1100 may transmit the query request including information about the 0-th node identifier NID_0 and “k” to the storage controller 1210. Operation S310 is similar to operation S110 of FIG. 6, and thus, additional description will be omitted to avoid redundancy.

In operation S321, the storage controller 1210 may transmit the read command for reading an a-th replaced index data rIND_a to the memory device 1220. In operation S322, the memory device 1220 may transmit the a-th replaced index data rIND_a to the storage controller 1220 in response to the read command.

In some implementations, when beam search corresponding to the 0-th node identifier NID_0 is performed (i.e., when beam search is first started), the storage controller 1210 may generate the 0-th physical address PA0 based on the 0-th node identifier NID_0 and may read replaced index data stored in an area corresponding to the 0-th physical address PA0. When a previously determined candidate node exists (i.e., when beam search is being performed), the storage controller 1210 may read replaced index data based on the physical address PA included in the replaced index data rIND.

In operation S323, the storage controller 1210 may perform beam search by using the replaced index data rIND. In operation S324, the storage controller 1210 may determine whether the search is done. Operation S323 and operation S324 are similar to operation S123 and operation S124 of FIG. 6, and thus, additional description will be omitted to avoid redundancy.

When the search is done, in operation S325, the storage controller 1210 may replace a physical address with a node identifier. For example, the storage controller 1210 may perform beam search, based on the replaced index data rIND. In this case, in association with the candidate nodes CND, instead of a node identifier, physical addresses corresponding to the candidate nodes CND may be stored in the beam search circuit 1211. Accordingly, the storage controller 1210 may replace the physical addresses PA corresponding to the candidate nodes CND with node identifiers.

Afterwards, the host device 1100, the storage controller 1210, and the memory device 1220 may perform operation S330 to operation S350.

As described above, the storage controller 1210 may perform beam search on the input node identifier NID_0 in response to the query request from the host device 1100. In this case, the storage controller 1210 may replace the neighbor node identifier nbrID stored in the index data IND with the physical address PA, so as to be stored in the memory device 1220. In this case, the physical address PA may indicate an area corresponding to the physical address PA at which the index data IND corresponding to the neighbor node identifier nbrID are stored. In other words, the index data IND corresponding to the neighbor node identifier nbrID may be directly stored in the memory device 1220. In this case, when beam search is repeatedly performed by the storage controller 1210 or the beam search circuit 1211, the intervention of the FTL for determining a storage location of index data may not be required, and thus, a beam search speed may be improved.

In the above implementation, the FTL 1214 may not be intervened in the process of reading index data during the beam search, but address translation may be performed by the FTL 1214 during an operation of converting the index data into replaced index data, an operation of translating a neighbor node identifier into a physical address, or an operation of writing the index data in the memory device 1220.

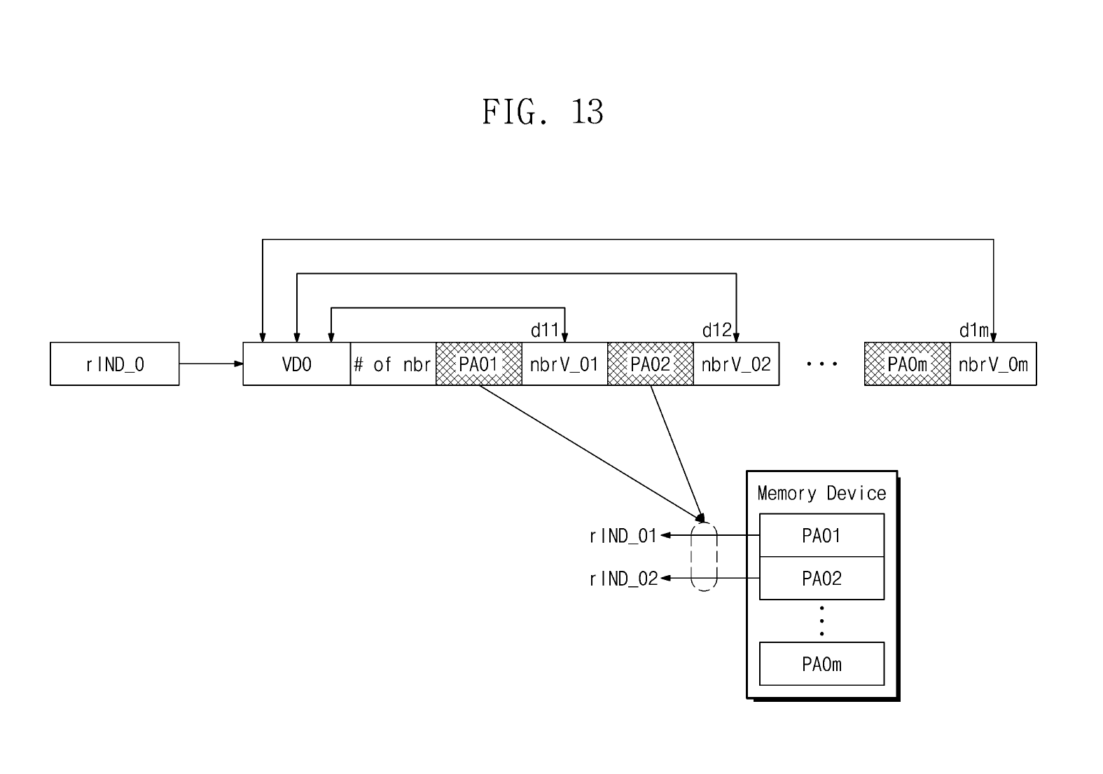

FIG. 13 is a diagram for describing an operation based on the flowchart of FIG. 12, according to some implementations of the present disclosure. For convenience of description, components which are unnecessary to describe an operation based on the flowchart of FIG. 12 are omitted. Referring to FIGS. 1, 12, and 13, the 0-th replaced index data rIND_0 may include the 0-th vector data VD0, the number of neighbor nodes, denoted as “# of nbr”, the plurality of physical addresses PA01 to PA0m, and the plurality of neighbor node vector values nbrV_01 to nbrV_0m.

The beam search circuit 1211 of the storage controller 1210 may perform distance calculation and nearest distance selection based on the 0-th replaced index data rIND_0. For example, as in the above description given with reference to FIG. 7B, the storage controller 1210 may calculate the 01-th distance d01 between the 0-th vector data VD0 and the 01-th neighbor node vector value nbrV_01, the 02-th distance d02 between the 0-th vector data VD0 and the 02-th neighbor node vector value nbrV_02, and the 0m-th distance d0m between the 0-th vector data VD0 and the 0m-th neighbor node vector value nbrV_0m.

The 01-th distance d01 and the 02-th distance d02 among the plurality of distances d01 to d0m may be selected by the beam search circuit 1211 as the nearest distance. Accordingly, the beam search circuit 1211 may continuously perform beam search on a 01-th neighbor node corresponding to the 01-th neighbor node vector value nbrV_01 and a 02-th neighbor node corresponding to the 02-th neighbor node vector value nbrV_02. To this end, the beam search circuit 1211 may read the 01-th and 02-th replaced index data rIND_01 and rIND_02 corresponding to the 01-th and 02-th neighbor nodes from the memory device 1220.

In this case, the beam search circuit 1211 may read the 01-th replaced index data rIND_01 from the memory device 1220 by using the 01-th physical address PA01 of the 0-th replaced index data rIND_0, which corresponds to the 01-th neighbor node vector value nbrV_01. The beam search circuit 1211 may read the 02-th replaced index data rIND_02 from the memory device 1220 by using the 02-th physical address PA02 of the 0-th replaced index data rIND_0, which corresponds to the 02-th neighbor node vector value nbr02_V. That is, in the case of repeatedly reading index data, the beam search circuit 1211 may read the index data by using a physical address included in the replaced index data rIND without intervention of the FTL 1214.

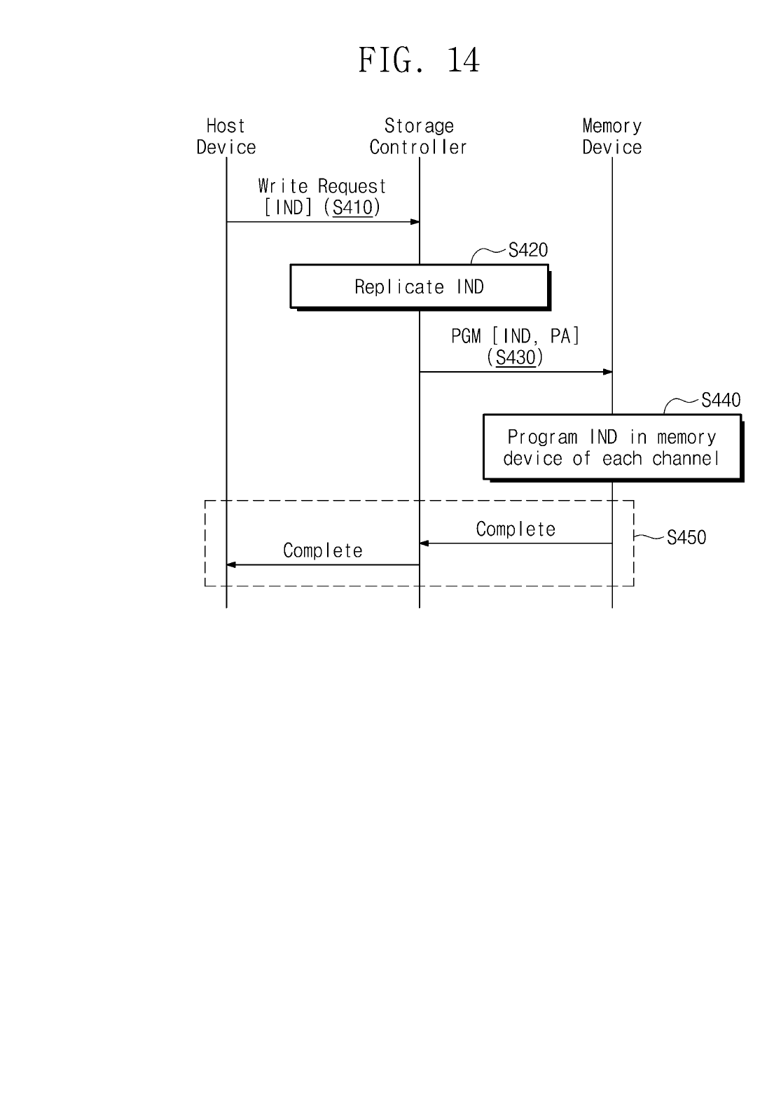

FIG. 14 is a flowchart illustrating an operation of a storage system of FIG. 1, according to some implementations of the present disclosure. Referring to FIGS. 1 and 14, in operation S410, the host device 1100 may transmit, to the storage device 1200, the write request for storing the index data IND in the storage device 1200. Operation S410 is similar to operation S210 of FIG. 10, and thus, additional description will be omitted to avoid redundancy.

In operation S420, the storage controller 1210 may replicate the index data IND. For example, the memory device 1220 may include a plurality of memories configured to communicate with the storage controller 1210 through a plurality of channels. Memories connected to different channels may operate independently of each other. The storage controller 1210 may replicate the index data IND such that the same index data IND are stored in the plurality of memories connected to the plurality of channels.

In operation S430, the storage controller 1210 may transmit the program command for storing the index data IND in the plurality of memories to the memory device 1220. In some implementations, the program command may be transmitted to each of the plurality of memories connected to the plurality of channels.

In operation S440, the memory device 1220 may program the index data IND in memories of each channel. Afterwards, in operation S450, the storage controller 1210 may receive information about program completion from the memory device 1220 and may transmit the information about program completion to the host device 1100.

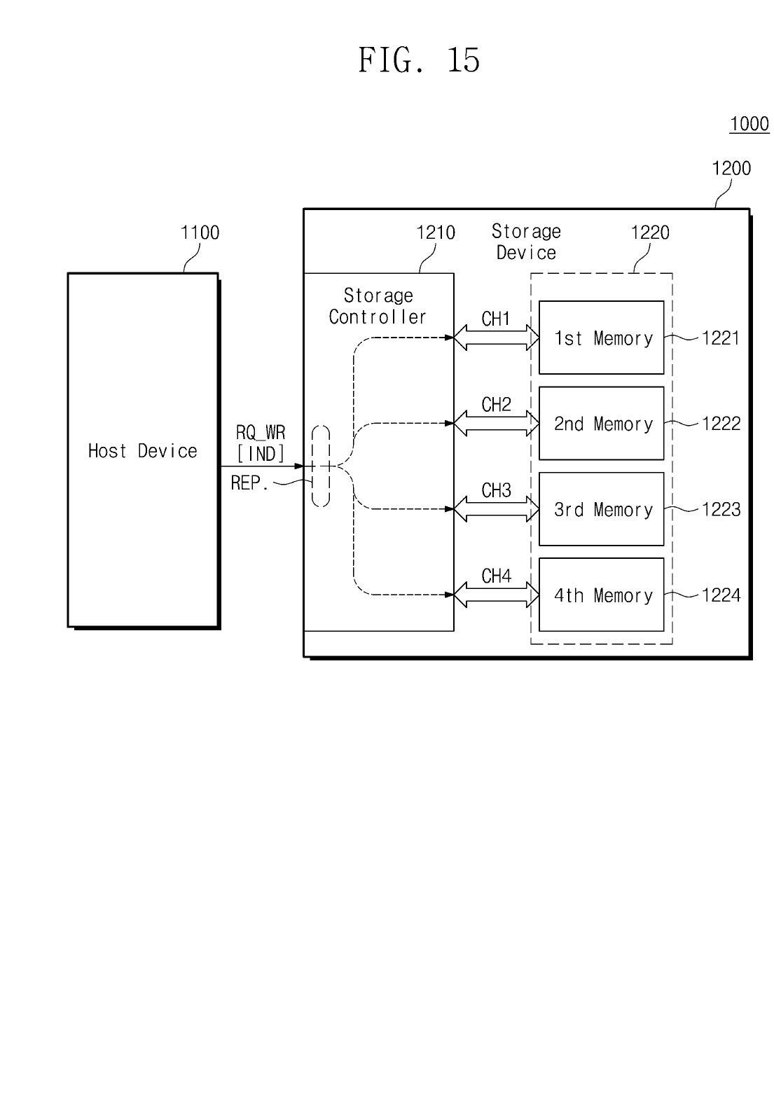

FIG. 15 is a diagram for describing an operation based on the flowchart of FIG. 14, according to some implementations of the present disclosure. Referring to FIGS. 1, 14, and 15, the storage device 1000 may include the host device 1100 and the storage device 1200. The storage device 1200 may include the storage controller 1210 and the memory device 1220. The memory device 1220 may include a plurality of memories 1221 to 1224. The storage controller 1210 may individually communicate with the plurality of memories 1221 to 1224 through a plurality of channels CH1 to CH4.

To store the index data IND in the storage device 1200 (or the memory device 1220), the host device 1100 may transmit a write request RQ_WR to the storage device 1210. The storage controller 1210 may replicate the index data IND in response to the write request RQ_WR. The replicated index data IND may be stored in each of the plurality of memories 1221 to 1224 through the plurality of channels CH1 to CH4.

For example, the host device 1100 may issue the write request for the 0-th index data IND0. In this case, the storage controller 1210 may transmit the 0-th index data to the first memory 1221 through the first channel CH1, may transmit the 0-th index data to the second memory 1222 through the second channel CH2, may transmit the 0-th index data to the third memory 1223 through the third channel CH3, and may transmit the 0-th index data to the fourth memory 1224 through the fourth channel CH4. Each of the first to fourth memories 1221 to 1224 may store the 0-th index data thus received. In other words, the 0-th index data may be stored in each of the first to fourth memories 1221 to 1224.

In some implementations, the first to fourth memories 1221 to 1224 respectively connected to the first to fourth channels CH1 to CH4 may operate independently of each other. That is, the operations in which the replicated index data are transmitted to the first to fourth memories 1221 to 1224 through the first to fourth channels CH1 to CH4 may be performed simultaneously or in parallel. The operations in which the replicated index data are programmed in the first to fourth memories 1221 to 1224 may be performed simultaneously or in parallel.

In some implementations, the same index data may be stored in areas of the first to fourth memories 1221 to 1224, which correspond to the same physical address. For example, first index data may be stored in areas of the first to fourth memories 1221 to 1224, which correspond to a first physical address. That is, when read operations on the first physical address are respectively performed in the first to fourth memories 1221 to 1224, the first index data may be read from each of the first to fourth memories 1221 to 1224.

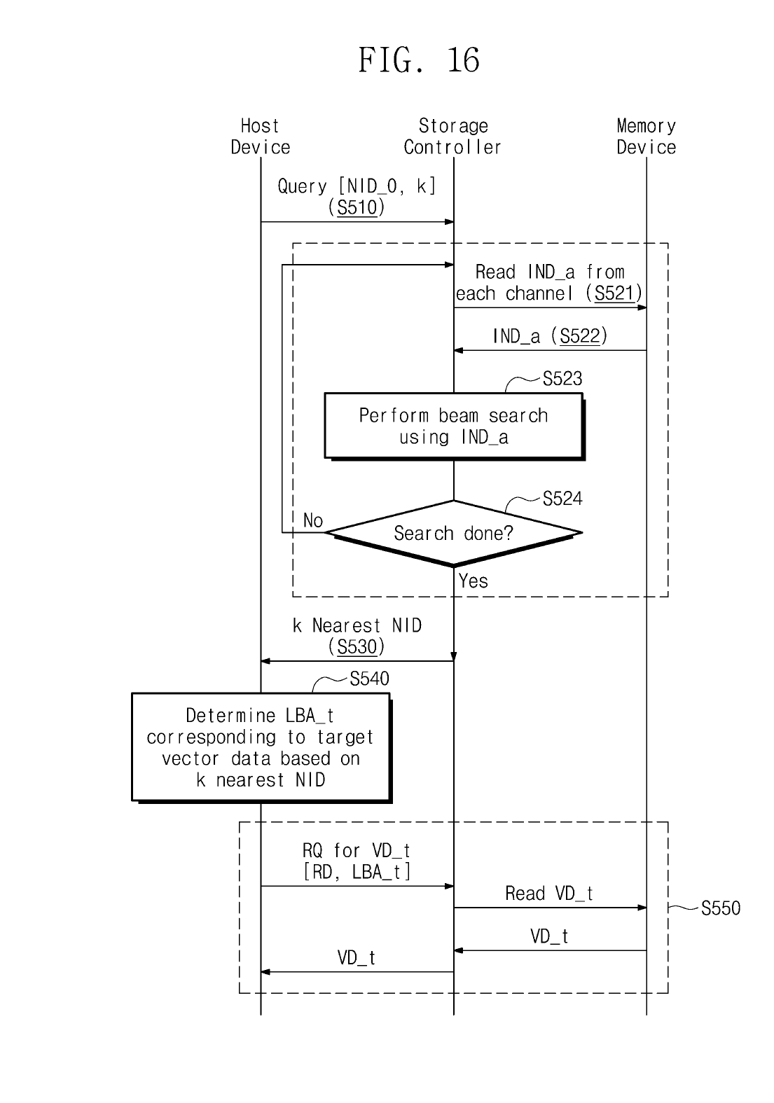

FIG. 16 is a flowchart illustrating a storage system of FIG. 1, according to some implementations of the present disclosure. For convenience of description, additional description associated with the components described above will be omitted to avoid redundancy. In operation S510, the host device 1100 may transmit the query request including information about the 0-th node identifier NID_0 and “k” to the storage controller 1210. Operation S510 is similar to operation S110 of FIG. 6, and thus, additional description will be omitted to avoid redundancy.

In operation S521, the storage controller 1210 may transmit the read command for reading the a-th index data IND_a to the memory device 1220. In operation S522, the memory device 1220 may transmit the a-th index data IND_a to the storage controller 1210 in response to the read command. In operation S523, the storage controller 1210 may perform beam search by using the a-th index data IND_a. In operation S524, the storage controller 1210 may determine whether the search is done. Operation S521 to operation S524 are similar to operation S121 to operation S124 of FIG. 6, and thus, additional description will be omitted to avoid redundancy.

In some implementations, to perform beam search, the beam search circuit 1211 of the storage controller 1210 may require a plurality of index data. In this case, in operation S521, the storage controller 1210 may read a plurality of index data in parallel from a plurality of memories connected to a plurality of channels. For example, as described with reference to FIGS. 14 and 15, it is assumed that the plurality of memories 1221 to 1224 may be in a state where the first to fourth index data are respectively stored therein and the first to fourth index data are required for beam search. In this case, the storage controller 1210 may read the first index data from the first memory 1221 connected to the first channel CH1, may read the second index data from the second memory 1222 connected to the second channel CH2, may read the third index data from the third memory 1223 connected to the third channel CH3, and may read the fourth index data from the fourth memory 1224 connected to the fourth channel CH4. This may mean that the first to fourth index data are read simultaneously or in parallel from the plurality of memories 1221 to 1224 through the plurality of channels CH1 to CH4. Accordingly, a time necessary to read the index data may decrease.

Afterwards, the host device 1100, the storage controller 1210, and the memory device 1220 may perform operation S530 to operation S550. Operation S530 to operation S550 are similar to operation S130 to operation S150 of FIG. 6, and thus, additional description will be omitted to avoid redundancy.

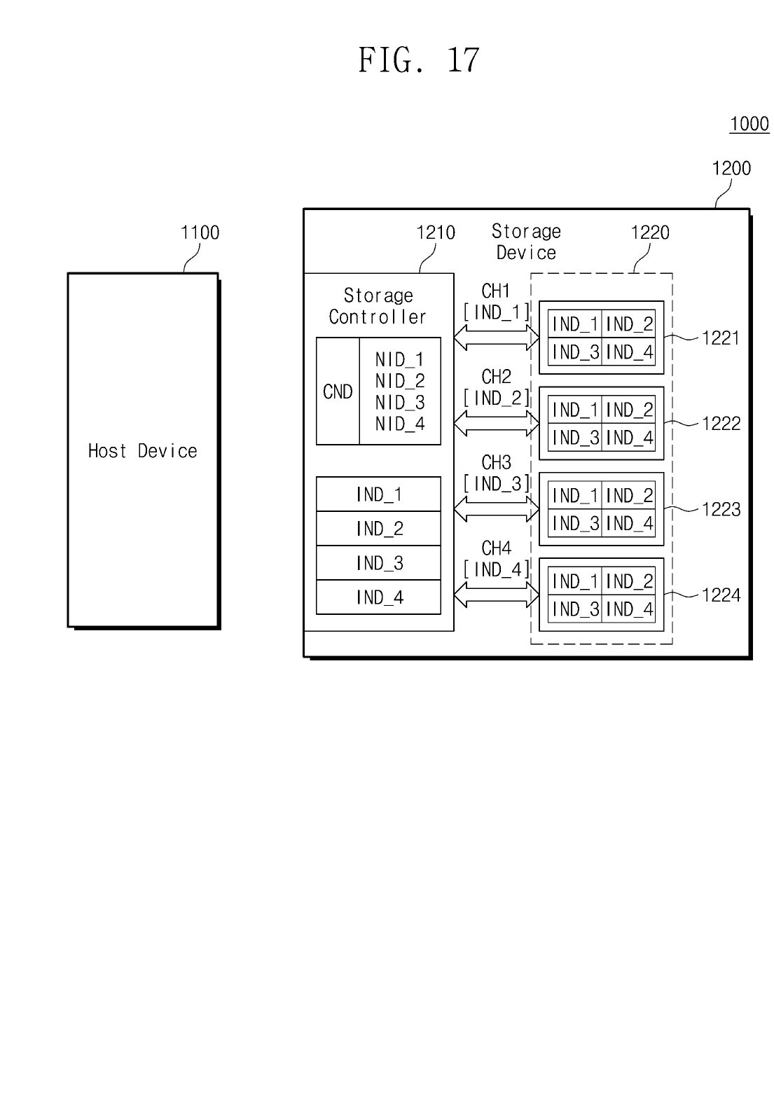

FIG. 17 is a diagram for describing an operation based on the flowchart of FIG. 16, according to some implementations of the present disclosure. Referring to FIGS. 1, 16, and 17, the storage controller 1210 may perform beam search in response to the query request of the host device 1100. During the beam search, the first to fourth node identifiers NID_1 to NID_4 may be selected as the candidate node CND.

To continuously perform the beam search, the storage controller 1210 may read the first to fourth index data IND_1 to IND_4 corresponding to the first to fourth node identifiers NID_1 to NID_4 from the memory device 1220. In this case, the storage controller 1210 may read the first to fourth index data IND_1 to IND_4 from the first to fourth memories 121 to 1224 of the memory device 1220. For example, the first to fourth memories 1221 to 1224 of the memory device 1220 may store the first to fourth index data IND_1 to IND_4, respectively. The storage controller 1210 may read the first index data IND_1 from the first memory 1221 through the first channel CH1, may read the second index data IND_2 from the second memory 1222 through the second channel CH2, may read the third index IND_3 from the third memory 1223 through the third channel CH3, and may read the fourth index data IND_4 from the fourth memory 1224 through the fourth channel CH4. In this case, because the first to fourth index data IND_1 to IND_4 are read simultaneously or in parallel from the first to fourth memories 1221 to 1224, a time necessary to read the index data may be shortened.

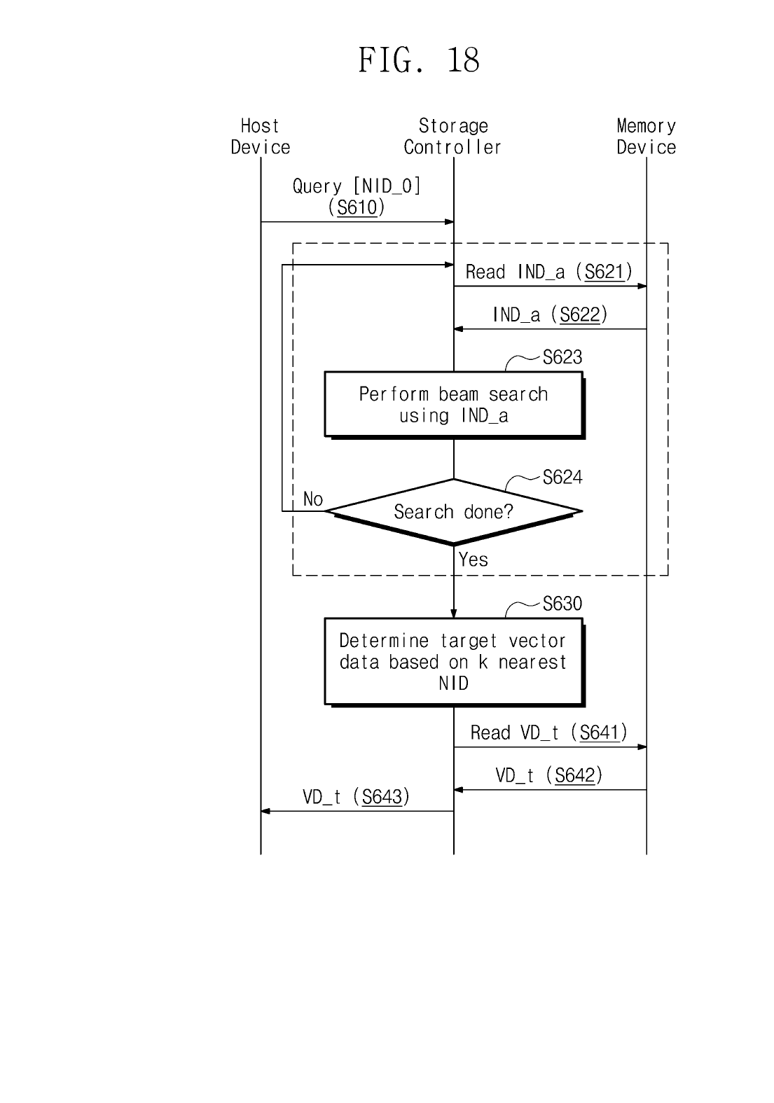

FIG. 18 is a flowchart illustrating a storage system of FIG. 1, according to some implementations of the present disclosure. Referring to FIGS. 1 and 18, in operation S610, the host device 1100 may transmit a query request including information about the 0-th node identifier NID_0 and “k” to the storage controller 1210. In operation S621, the storage controller 1210 may transmit the read command for reading the a-th index data IND_a to the memory device 1220. In operation S622, the memory device 1220 may transmit the a-th index data IND_a to the storage controller 1210. In operation S623, the storage controller 1210 may perform beam search by using the a-th index data IND_a. In operation S624, the storage controller 1210 may determine whether the beam search is done. Operation S610 to operation S624 are similar to operation S110 to operation S124 of FIG. 6, and thus, additional description will be omitted to avoid redundancy.

In operation S630, the storage controller 1210 may determine target vector data, based on k neighbor node identifiers. For example, the storage controller 1210 may be configured to execute the artificial intelligence model implemented by the host device 1100. In this case, the storage controller 1210 may determine the target vector data, based on the k neighbor node identifiers determined through the beam search.

In operation S641, the storage controller 1210 may transmit the read command for reading the target vector data VD_t to the memory device 1220. In operation S642, the memory device 1220 may transmit the target vector data VD_t to the storage controller 1210 in response to the read command. In operation S643, the storage controller 1210 may transmit the target vector data VD_t to the host device 1100.

As described above, according to some implementations of the present disclosure, the storage controller 1210 may perform beam search on the input node in response to the query request of the host device 1100. The storage controller 1210 may provide the k neighbor node identifiers to the host device 1100 as a beam search result. In this case, because an operation in which the index data are repeatedly transmitted to the host device 1100 is omitted, the performance of the storage system 1000 may be improved.

In some implementations, the storage controller 1210 may execute at least portion of the artificial intelligence model implemented by the host device 1100; in this case, the storage controller 1210 may perform beam search in response to the query request of the host device 1100 and may transmit the target vector data to the host device 1100 as a beam search result.

The above implementations may be carried out individually, or at least two of the above implementations may be combined.

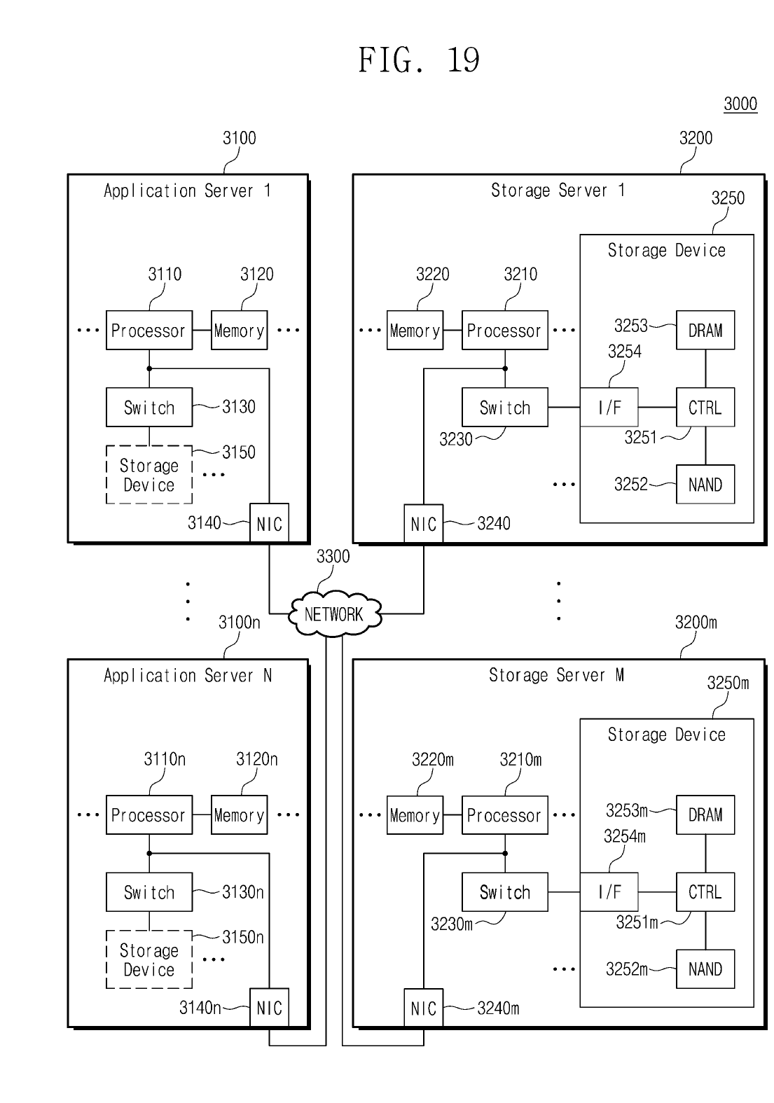

FIG. 19 is a diagram of a data center 3000 to which a storage device is applied, according to some implementations.

Referring to FIG. 19, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to implementations. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some implementations, the numbers of processors 3210 and memories 3220 included in the storage server 3200 may be variously selected. In some implementations, the processor 3210 and the memory 3220 may provide a processor-memory pair. In some implementations, the number of processors 3210 may be different from the number of memories 3220. The processor 3210 may include a single-core processor or a multi-core processor. The above description of the storage server 3200 may be similarly applied to the application server 3100. In some implementations, the application server 3100 may not include a storage device 3150. The storage server 3200 may include at least one storage device 3250. The number of storage devices 3250 included in the storage server 3200 may be variously selected according to implementations.

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In some implementations, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another implementation, the network 3300 may be a general network, such as a TCP/IP network. For example, the network 3300 may be implemented according to a protocol, such as FC over Ethernet (FCoE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC(Network InterConnect) 3240. The switch 3230 may selectively connect the processor 3210 to the storage device 3250 or selectively connect the NIC 3240 to the storage device 3250 via the control of the processor 3210.

In some implementations, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In some implementations, the NIC 3240 may be integrated with at least one of the processor 3210, the switch 3230, and the storage device 3250.

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

The controller 3251 may control all operations of the storage device 3250. In some implementations, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

According to the present disclosure, a storage device may perform beam search on a vector database depending on a request of a host device. In this case, because an operation in which index data of the vector database are repeatedly transmitted to the host device is not performed, a speed at which beam search on the vector database is performed may be improved. Accordingly, a storage device with improved performance, a storage system, and an operation method of the storage device are provided.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been described with reference to implementations thereof, it will be apparent to those of ordinary skill in the art that various changes and modifications may be made thereto without departing from the spirit and scope of the present disclosure as set forth in the following claims.

Below, implementations of the present disclosure will be described in detail and clearly to such an extent that an ordinary one in the art easily carries out the present disclosure.

The terms, which are used below, such as “block”, “unit”, and “module” or components corresponding thereto, or functional blocks or circuits in drawings may be implemented in the form of software, hardware, or a combination thereof, which is configured to perform or process various functions, operations, or features described in the detailed description.

Below, when various components are listed by using the conjunction “or”, this may refer to each of the listed components or a combination of at least some of the listed components. For example, “A, B, or C” may refer to A, B, and C respectively or may refer to a combination of A and B, a combination of B and C, a combination of A and C, or a combination of A, B, and C.

FIG. 1 is a block illustrating a storage system according to some implementations of the present disclosure. Referring to FIG. 1, a storage system 1000 may include a host device 1100 and a storage device 1200. In some implementations, the storage system 1000 may include at least one of various information processing devices such as a personal computer, a laptop computer, a server, a workstation, a smartphone, and a tablet PC. Alternatively, the storage system 1000 may be a data center configured to store and manage various data or may be a storage server or an application server included in the data center. In some implementations, the storage system 1000 may be an automotive electronic system such as a navigation system or an autonomous driving system.

The host device 1100 may control all operations of the storage system 1000. The host device 1100 may communicate with the storage device 1200 through a given interface. In some implementations, the given host interface may include at least one of various interfaces such as an ATA (Advanced Technology Attachment) interface, an SATA (Serial ATA) interface, an e-SATA (external SATA) interface, an SCSI (Small Computer Small Interface) interface, an SAS (Serial Attached SCSI) interface, a PCI (Peripheral Component Interconnection) interface, a PCIe (PCI express) interface, an NVMe (NVM express) interface, an IEEE 1394 interface, an USB (Universal Serial Bus) interface, an SD (Secure Digital) card interface, an MMC (Multi-Media Card) interface, an eMMC (embedded Multi-Media Card) interface, an UFS (Universal Flash Storage) interface, an eUFS (embedded Universal Flash Storage) interface, and a CF (Compact Flash) card interface. Through on a given interface, the host device 1100 may store data in the storage device 1200 or may read data stored in the storage device 1200.

The storage device 1200 may operate under control of the host device 1100. The storage device 1200 may include a storage controller 1210 and a memory device 1220. Under control of the host device 1100 or depending on a request of the host device 1100, the storage controller 1210 may store data in the memory device 1220 or may read data stored in the memory device 1220.

The memory device 1220 may operate under control of the storage controller 1210. In some implementations, the memory device 1230 may include a NAND flash memory device.

In some implementations, the storage system 1000 may be configured to implement or train a large language model (LLM) configured to perform various natural language processing (NLP). For example, the host device 1100 may be an accelerator configured to implement, train, or execute an artificial intelligence model or may include the accelerator. As an example, the accelerator included in the host device 1100 may include a graphics processing unit (GPU), a neural processing unit (NPU), or separate dedicated hardware. Alternatively, the storage system 1000 may be included in an application processor (AP) or may be included in a mobile device.

In some implementations, because a large language model such as an LLM is trained by using a vast amount of data, efficient management for data may be required. To this end, the host device 1100 may manage data necessary to implement, train, or execute the artificial intelligence model by using a vector database VDB. When the host device 1100 implements, trains, or executes the artificial intelligence model based on the vector database VDB, it may be easy to access intended information or data.

In some implementations, the memory device 1220 of the storage device 1200 may store the vector database VDB. The vector database VDB may indicate a data structure which stores or manages information or data necessary for the artificial intelligence model in the form of a vector. The vector database VDB may include vector data VD and index information INDX. The vector data VD may have formats in which various types of data are embedded. The index information INDX may include information about the data structure of the vector data VD included in the vector database VDB. In some implementations, the index information INDX may indicate information for mapping embedded vector data to a given structure by using a hashing, quantization, or graph-based technique.

In some implementations, the host device 1100 may determine a target vector data for input data through the artificial intelligence model. The target vector data may indicate data having high correlation with input data or initial data. When all the vector data and the input data are compared to determine the target vector data, the burden of computation of the host device 1100 increases. To prevent the above issue, the beam search for the vector database VDB may make it easy to search the vector database VDB and determine the target vector data.

In some implementations, the host device 1100 may load the index information INDX to a host memory to search the vector database VDB. However, when the capacity of the vector data VD increases, the capacity of the index information INDX may also increase. In this case, due to the limited capacity of the host memory, the entire index information INDX is incapable of being loaded to the host memory. According to the above description, whenever the search is required, the host device 1100 should read the required index information INDX from the storage device 1200. The iterative read operation on the index information INDX causes the reduction of performance of the artificial intelligence computation (e.g., the delay of the beam search) of the storage system 1000 or the host device 1100.

In some implementations, the storage controller 1210 may include a beam search circuit 1211. The beam search circuit 1211 may perform beam search in response to a query request of the host device 1100. For example, the beam search is a search algorithm which explores a graph by expanding the most promising node in a limited set. For example, the beam search circuit 1211 may receive information about a start node identifier and “k” from the host device 1100. In some implementations, “k” may be a natural number. In this case, the beam search circuit 1211 may read index data corresponding to the start node identifier from the index information INDX of the memory device 1220 and may search for neighbor nodes to a start node. In some implementations, to search for the neighbor nodes may indicate an operation of calculating distances between the start node and the neighbor nodes and selecting nodes having the shortest distance from among the calculated nodes. In some implementations, the index data corresponding to the start node identifier is not transmitted to the host device 1100.

The beam search circuit 1211 may read other index data corresponding to the selected neighbor nodes from the index information INDX of the memory device 1220 and may search for other neighbor nodes based on the other index data thus read. The beam search circuit 1211 may repeatedly perform the above operation and may provide the host device 1100 with node identifiers corresponding to k nodes neighbor to the start node identifier. A structure and an operation of the storage controller 1210 or the beam search circuit 1211 according to some implementations of the present disclosure will be described in detail with reference to the following drawings.

According to the above operation, because the search (e.g., the beam search) for the vector database VDB is performed by the beam search circuit 1211 of the storage controller 1210, the transmission of the index information INDX between the host device 1100 and the storage device 1200 may be omitted. Accordingly, a speed at which the vector database VDB is searched may be improved.

FIG. 2 is a block diagram illustrating a storage controller of FIG. 1. Referring to FIGS. 1 and 2, the storage controller 1210 may include the beam search circuit 1211, a processor 1212, a random access memory (RAM) 1213, a flash translation layer (FTL) 1214, an error correction code (ECC) engine 115, an advanced encryption standard (AES) engine 115, a host device interface circuit 1217, and a memory interface circuit 1218. The beam search circuit 1211 is described above, thus, additional description will be omitted to avoid redundancy. The beam search circuit 1211 will be described in detail with reference to the following drawings.

The processor 1212 may control all operations of the storage controller 1210. For example, the processor 1212 may execute various applications on the controller 1210. The RAM 1213 may be configured to store various information necessary for the storage controller 1210 to operate. In some implementations, the RAM 1210 may be used as a working memory, a cache memory, or a buffer memory of the controller 1210.

The FTL 1214 may perform maintenance operations for efficiently managing or using the memory device 1220. In some implementations, the maintenance operations may include an address mapping operation, a wear-leveling operation, a garbage collection operation, etc.

The address mapping operation of the FTL 1214 may refer to an operation of translating a logical address received from the host device 1100 into a physical address to be used to actually store data in the memory device 1220. In some implementations, the FTL 1214 may perform the address mapping operation by using L2P map data. The wear-leveling operation of the FTL 1214 may refer to an operation of preventing excessive degradation of a specific memory block among the memory blocks included in the memory device 1220. The garbage collection operation of the FTL 1214 may refer to an operation of securing a memory block or a capacity available in the memory devices 1220 by copying valid data of a source memory block to a target memory block and then switching the source memory block into a free block or erasing the source memory block. The FTL 1214 may further perform various management operations such as a bad block management operation, in addition to the above operations. In some implementations, some or all of the functions of the FTL 1214 may be implemented through software, hardware, or a combination thereof.

The ECC engine 1215 may perform an error detection and correction function on data read from the memory device 1220. For example, the ECC engine 1215 may generate parity bits for write data to be written in the memory device 1220, and the parity bits thus generated may be stored in the memory device 1220 together with the write data. When data are read from the memory device 1220, the ECC engine 1215 may correct an error of the read data by using the parity bits read from the memory device 1220 together with the read data and may output the error-corrected read data.

The AES engine 1216 may perform at least one of an encryption operation and a decryption operation on data input to the storage controller 1210 by using a symmetric-key algorithm.

The host device interface circuit 1217 may communicate with the host device 1100 based a host device interface. In some implementations, the host device interface may include at least one of various interfaces such as an ATA (Advanced Technology Attachment) interface, an SATA (Serial ATA) interface, an e-SATA (external SATA) interface, an SCSI (Small Computer Small Interface) interface, an SAS (Serial Attached SCSI) interface, a PCI (Peripheral Component Interconnection) interface, a PCIe (PCI express) interface, an NVMe (NVM express) interface, an IEEE 1394 interface, an USB (Universal Serial Bus) interface, an SD (Secure Digital) card interface, an MMC (Multi-Media Card) interface, an eMMC (embedded Multi-Media Card) interface, an UFS (Universal Flash Storage) interface, an eUFS (embedded Universal Flash Storage) interface, and a CF (Compact Flash) card interface.

The memory interface circuit 1218 may communicate with the memory device 1220 based on a memory interface. In some implementations, the memory interface may include one of interfaces such as a toggle interface or an open NAND flash interface (ONFI).

FIG. 3 is a diagram for describing beam search performed by a beam search circuit of FIG. 2. Referring to FIGS. 2 and 3, the beam search circuit 1211 may perform beam search for an input node depending on a request of the host device 1100. For example, as illustrated in FIG. 3, it is assumed that a 0-th node is a start node. In this case, at step 1, nodes adjacent to the 0-th node may be first-searched. For example, a distance of each of nodes A, B, C, D, E adjacent to the 0-th node may be calculated. As an example, the distance may indicate similarity metrics between two nodes. As an example, the similarity metrics may include metrics such as cosine similarity, a Euclidean distance, a dot product.

As an example, nodes the nearest to the 0-th node may be nodes 0A and 0B, and the nodes 0A and 0C may be selected as a candidate node of step 1. Afterwards, at step 2, nodes A, B, C, D, and E adjacent to the nodes 0A and 0C being the candidate nodes may be second-searched. For example, a distance between the node 0A and each of the nodes A, B, C, D, and E adjacent thereto may be calculated, and a distance between the node 0C and each of the nodes A, B, C, D, and E adjacent thereto may be calculated. In this case, the nearest nodes may be nodes 0AD and 0CB, and the nodes 0AD and 0CB may be selected as a candidate node of step 2.

Afterwards, at step 3, nodes A, B, C, D, and E adjacent to the nodes 0AD and 0CB may be third-searched. For example, a distance between the node 0AD and each of the nodes A, B, C, D, and E adjacent thereto may be calculated, and a distance between the node 0CB and each of the nodes A, B, C, D, and E adjacent thereto may be calculated. In this case, the nearest nodes may be nodes 0ADE and 0CBD, and the nodes 0ADE and 0CBD may be selected as a candidate node of step 3. The candidate nodes selected at step 3 may be determined as nodes the nearest to the 0-th node being the start node.

For illustrative purposes, the description is given as step 1 to step 3 may be performed in the beam search. The iterative number of times of each search or each step and the number of candidate nodes selected at each step may be variously changed.

As described above, in the beam search operation, an operation of searching for nodes adjacent to an input node may be repeatedly performed. In some implementations, the search operation may include distance calculation and nearest distance selection. In the implementation of FIG. 3, the search operation is iterated three times. That is, when the beam search is performed by the host device 1100, an operation of reading the index information INDX from the storage device 1200 is iterated at least three times. In contrast, when the beam search is performed by the beam search circuit 1211 of the storage device 1200, the above search operation may be performed without transmitting the index information INDX from the storage device 1200 to the host device 1100.

FIG. 4 is a diagram illustrating index information stored in a memory device of FIG. 1. Referring to FIGS. 1 and 4, the index information INDX may include a plurality of index data IND_0 to IND_n. Each of the plurality of index data IND_0 to IND_n may respectively correspond to a plurality of node identifiers NID_0 to NID_n and may include structure information about a plurality of vector data VD0 to VDn. For example, the 0-th index data IND_0 may correspond to the 0-th node identifier NID_0 and may include structure information about the 0-th vector data VD0 corresponding to the 0-th node identifier NID_0. As an example, the 0-th index data IND_0 may include the number of nodes adjacent to the 0-th vector data VD0, denoted as “# of nbr”, a plurality of neighbor node identifiers nbrID_01 to nbrID_0m, and a plurality of neighbor vector values nbrV_01_V to nbrV_0m. The plurality of neighbor node identifiers nbrID_01 to nbrID_0m may indicate identifiers of nodes adjacent to the 0-th vector data VD0. For example, referring to the implementation of FIG. 3, it is assumed that the 0-th vector data VD0 correspond to the 0-th node. In this case, neighbor nodes of the 0-th vector data VD0 may be the nodes A, B, C, D, and E, and the plurality of neighbor node identifiers nbrID_01 to nbrID_0m may be identifiers of the nodes A, B, C, D, and E. The plurality of neighbor vector values nbrV_01 to nbrV_0m may be quantization values of vector data corresponding to the plurality of neighbor node identifiers nbrID_01 to nbrID_0m. For example, the first neighbor vector value nbrV_01 may indicate a quantization value of vector data corresponding to the first neighbor node identifier nbrID_01. The first index data IND_1 may include first vector data VD1, the number of nodes adjacent to the 1-th vector data VD1, denoted as “# of nbr”, a plurality of neighbor node identifiers nbrID_11 to nbrID_1m, and a plurality of neighbor vector values nbrV_11 to nbrV_1m. Each factor is similar to that described above, and thus, additional description will be omitted to avoid redundancy.

In some implementations, it is assumed that distance calculation and nearest distance selection are performed in association with the 0-th node. In this case, the distance calculation may be performed based on the 0-th index data IND_0 corresponding to the 0-th node. For example, a distance between the 0-th node and a node corresponding to the 01-th neighbor node identifier nbrID_01 may be calculated based on the 0-th vector data VD0 and the 01-th neighbor vector value nbrV_01 of the 0-th index data IND_0. Likewise, a distance between the 0-th node and a node corresponding to the 02-th neighbor node identifier nbrID_02 may be calculated based on the 0-th vector data VD0 and the 02-th neighbor vector value nbrV_02 of the 0-th index data IND_0. There may be selected k neighbor nodes having the nearest distance from among the distances obtained through the above calculation. The above operation may be repeatedly performed based on index data corresponding to the selected k neighbor nodes.

FIG. 5 is a flowchart illustrating an operation of a storage system of FIG. 1. Referring to FIGS. 1 and 5, in operation S10, the host device 1100 may transmit a request for reading an a-th index data IND_a to the storage controller 1210 of the storage device 1200. For example, the host device 1100 may perform distance calculation and nearest distance selection corresponding to an a-th node. To this end, the host device 1100 may require the a-th index data IND_a corresponding to the a-th node. To read the a-th index data IND_a, the host device 1100 may transmit an a-th logical address LAB_a and a read request RD to the storage controller 1210 of the storage device 1200.

In operation S11, the storage controller 1210 may transmit a read command for the a-th index data IND_a to the memory device 1220 in response to the request from the host device 1100. In operation S12, the memory device 1220 may transmit the a-th index data IND_a to the storage controller 1210 in response to the read command. In operation S13, the storage controller 1210 may transmit the a-th index data IND_a to the host device 1100.

In operation S14, the host device 1100 may perform beam search by using the received a-th index data IND_a. For example, the host device 1100 may perform distance calculation and nearest distance selection based on information (e.g., vector values corresponding to neighbor nodes) included in the a-th index data IND_a. The distance calculation and the nearest distance selection are described with reference to FIGS. 3 and 4, and thus, additional description will be omitted to avoid redundancy.

In operation S15, the host device 1100 may determine whether the beam search is done. For example, the host device 1100 may determine whether the distance calculation and the nearest distance selection are performed as much as the given number of times.

When the beam search is not done, the host device 1210, the storage controller 1210, and the memory device 1220 may repeatedly perform operation S10, operation S11, operation S12, operation S13, and operation S14. In this case, the host device 1210, the storage controller 1210, and the memory device 1220 may perform the above operations based on index data corresponding to candidate nodes selected based on the nearest distance in a previous process.

When the beam search is done, in operation S16, the host device 1100 may determine a target logical address LBA_t corresponding to target vector data VD_t based on k nearest distance nodes. For example, the host device 1100 may determine a final target vector data VD_t by performing an artificial intelligence operation based on the k nearest distance nodes..

In operation S17, the host device 1210, the storage controller 1210, and the memory device 1220 may perform the read operation on the target vector data VD_t. For example, to read the target vector data VD_t, the host device 1100 may transmit the read request RD and the target logical address LBA_t to the storage controller 1210. The storage controller 1210 may transmit the read command for reading the target vector data VD_t to the memory device 1220 in response to the read request RD. The memory device 1200 may transmit the target vector data VD_t to the storage controller 1210 in response to the read command. The storage controller 1210 may transmit the target vector data VD_t to the host device 1100.

FIG. 6 is a flowchart illustrating a storage system of FIG. 1, according to some implementations of the present disclosure. Referring to FIGS. 1 and 6, in operation S110, the host device 1100 may transmit a query request including information about the 0-th node identifier NID_0 and “k” to the storage controller 1210. In some implementations, the host device 1100 may transmit the query request including vector data, not a node identifier. In some implementations, the “k” may indicate the number of nearest distance nodes which the host device 1100 wants to obtain as a search result.

For example, the host device 1100 may transmit, to the storage controller 1210, the query request for obtaining information about k nodes the nearest to the 0-th node identifier NID_0. In some implementations, the query request may be defined by the interface between the host device 1100 and the storage device 1200. Alternatively, the query request may be a user request or a vendor request specified by the interface between the host device 1100 and the storage device 1200.

In operation S121, the storage controller 1210 may transmit the read command for reading the a-th index data IND_a to the memory device 1220. In some implementations, the a-th index data IND_a may correspond to the 0-th node identifier NID_0. In operation S122, the memory device 1220 may transmit the a-th index data IND_a to the storage controller 1210.

In operation S123, the storage controller 1210 may perform beam search (e.g., may search for neighbor nodes) by using the a-th index data IND_a. For example, the a-th index data IND_a may include vector data corresponding to the 0-th node identifier NID_0, identifiers of neighbor nodes, and vector values. The beam search circuit 1211 of the storage controller 1210 may select the nearest distance by calculating distances between the 0-th node and the neighbor nodes by using information of the a-th index data IND_a.

In operation S124, the storage controller 1210 may determine whether the beam search is done. For example, the storage controller 1210 may determine whether the distance calculation and the nearest distance selection are iterated as much as the given number of times.

When the beam search is not done, the storage controller 1210 and the memory device 1220 may perform operation S121. In some implementations, in this case, the storage controller 1210 may perform the distance calculation and the nearest distance selection based on index data corresponding to candidate nodes determined by the binary beam search. For example, when a 01-th neighbor node is selected as a candidate node, the storage controller 1210 may read 01-th index data corresponding to the 01-th neighbor node from the memory device 1220 and may perform beam search based on the 01-th index data.

When the beam search is done, in operation S130, the storage controller 1210 may transmit neighbor node identifiers NID corresponding to k nearest nodes to the host device 1100. For example, through operation S121 to operation S124, the storage controller 1210 may perform beam search on the 0-th node identifier NID_0. That is, the storage controller 1210 may obtain information about the k node identifiers NID near to the 0-th node identifier NID_0. The information about the k node identifiers NID may be transmitted from the storage controller 1210 to the host device 1100 as a response to the query request in operation S110.

In operation S140, the host device 1100 may determine the target logical address LBA_t corresponding to the target vector data VD_t based on the k node identifiers NID. In operation S150, the host device 1210, the storage controller 1210, and the memory device 1220 may perform the read operation on the target vector data VD_t. Operation S140 and operation S150 are similar to operation S16 and operation S17 of FIG. 5, and thus, additional description will be omitted to avoid redundancy.

As described above, according to some implementations of the present disclosure, the storage controller 1210 may obtain node identifiers of k nodes near to an input node by performing beam search on the input node or a start node in response to the query request of the host device 1100. In this case, because an operation of transmitting/receiving index data to/from the host device 1100 is not performed, a beam search speed may be improved.

FIGS. 7A to 7C are diagrams for describing an operation based on the flowchart of FIG. 6, according to some implementations of the present disclosure. For convenience of description, components which are unnecessary to describe the beam search operation performed by the beam search circuit 1211 of the storage controller 1210 are omitted.

Referring to FIGS. 1, 7A, 7B, and 7C, in operation (1) of FIG. 7A, the beam search circuit 1211 may receive the query request from the host device 1100. The query request may include information requesting k node identifiers near to the 0-th node identifier NID_0.

In operation (2) of FIG. 7A, the beam search circuit 1211 may read the 0-th index data IND_0 corresponding to the 0-th node identifier NID_0 from the memory device 1220 in response to the query request. For example, the memory device 1220 may store the index information INDX including a plurality of index data. The beam search circuit 1211 may read the 0-th index data IND_0 corresponding to the 0-th node identifier NID_0 from among the plurality of index data included in the index information INDX from the memory device 1220 through the memory interface circuit 1218.

In operation (3) of FIG. 7B, the beam search circuit 1211 may calculate distances between respective nodes by using the 0-th index data IND_0 and may select the nearest nodes (i.e., may search for neighbor nodes). For example, as illustrated in FIG. 7B, the 0-th index data IND_0 may include the 0-th vector data VD0 corresponding to the 0-th node identifier NID_0, the number of neighbor nodes, denoted as “# of nbr”, the plurality of neighbor node identifiers nbrID_01 to nbrID_0m, and the plurality of neighbor vector values nbrV_01 to nbrV_0m.

The beam search circuit 1211 may calculate a 01-th distance d01 based on the 0-th vector data VD0 and the 01-th near vector value nbrV_01. The 01-th distance d01 may indicate a distance (e.g., cosine similarity, a Euclidean distance, or a dot product) between a node corresponding to the 0-th node identifier NID_0 and a node corresponding to the 01-th neighbor node identifier nbrID_01. Likewise, the beam search circuit 1211 may calculate a 02-th distance d02 based on the 0-th vector data VD0 and the 02-th neighbor vector value nbrV_02. The beam search circuit 1211 may calculate a 0m-th distance d0m based on the 0-th vector data VD0 and the 0m-th neighbor vector value nbrV_0m. That is, the beam search circuit 1211 may calculate distances d01 to d0m from the 0-th vector data VD0 to the respective neighbor vector values nbrV_01 to nbrV_0m included in the 0-th index data IND_0.

The beam search circuit 1211 may select k candidate nodes having the nearest distance from among the calculated distances d01 to d0m. For example, the 01-th and 02-th distances d01 and d02 among the calculated distances d01 to d0m may be the nearest distances (i.e., the nearest distance and the second nearest distance). In this case, the beam search circuit 1211 may select the 01-th neighbor node identifier nbrID_01 and the 02-th neighbor node identifier nbrID_02 corresponding to the 01-th and 02-th distances d01 and d02 as a candidate node.

In operation (4) of FIG. 7B, the beam search circuit 1211 may store the selected neighbor node identifiers as candidate nodes CND. For example, through the distance calculation and the nearest distance selection described above, the 01-th neighbor node identifier nbrID_01 and the 02-th neighbor node identifier nbrID_02 may be selected. In this case, the beam search circuit 1211 may store the 01-th node identifier NID_01 corresponding to the 01-th neighbor node identifier nbrID_01 and the 02-th node identifier NID_02 corresponding to the 02-th neighbor node identifier nbrID_02 as the candidate node CND. In some implementations, the candidate node CND may be used as an input node for distance calculation and nearest distance selection to be performed later. In operation (5) of FIG. 7C, the beam search circuit 1211 may read pieces of index data corresponding to the candidate node CND from the index information INDX of the memory device 1220. For example, as described above, the candidate nodes CND may include information about the 01-th node identifier NID_01 and the 02-th node identifier NID_02. In this case, the beam search circuit 1211 may read the 01-th index data IND_01 corresponding to the 01-th node identifier NID_01 and the 02-th index data IND_02 corresponding to the 02-th node identifier NID_02 from the memory device 1220.

In some implementations, the 01-th index data IND_01 may include vector data corresponding to the 01-th node identifier NID_01, the number of neighbor nodes, a neighbor node identifier, and a neighbor node vector value, and the 02-th index data IND_02 may include vector data corresponding to the 02-th node identifier NID_02, the number of neighbor nodes, a neighbor node identifier, and a neighbor node vector value.

In some implementations, the beam search circuit 1211 may select k candidate nodes having the nearest distance by performing distance calculation and nearest distance selection based on the 01-th index data IND_01 and 02-th index data IND_02. In some implementations, as the distance calculation and the nearest distance selection are repeatedly performed, the number of selected neighbor nodes may be variously changed.

In some implementations, the beam search circuit 1211 may select k neighbor nodes by repeatedly performing the above operation.

FIGS. 8A and 8B are timing diagrams illustrating an operation of a storage system of FIG. 1, according to some implementations of the present disclosure. For convenience of description, a data input/output or an operation of the host device 1100, the storage controller 1210, and the memory device 1220 is briefly expressed with reference to FIGS. 8A and 8B. An operation based on the flowchart of FIG. 5 will be described with reference to FIG. 8A, and an operation based on the flowchart of FIG. 6 will be described with reference to FIG. 8B.

First, referring to FIGS. 1, 5, and 8A, for the beam search operation, the host device 1100 may request the index data IND from the storage controller 1210 (refer to “RQ IND” in FIG. 8A). In response to the request, the storage controller 1210 may transmit a read command RD IND for reading the requested index data IND to the memory device 1220. The memory device 1220 may perform the read operation during a read time tRD in response to the read command RD IND. After the read operation, the memory device 1220 may transmit the index data IND to the storage controller 1210 (refer to “IND out” in FIG. 8A). The storage controller 1210 may receive the index data IND from the memory device 1220 and may transfer the received index data IND to the host device 1100. The host device 1100 may receive the index data IND and may perform beam search (e.g., neighbor node search or distance calculation and nearest distance selection) based on the received index data IND.

Afterwards, the host device 1100 may request the index data IND corresponding to candidate nodes from the storage controller 1210. The following operation is similar to that described above, and thus, additional description will be omitted to avoid redundancy.

Next, referring to FIGS. 1, 6, and 8B, the host device 1100 may transmit a query request for the 0-th node identifier NID_0 to the storage controller 1210. For example, the host device 1100 may require k nodes near to a node corresponding to the 0-th node identifier NID_0. In this case, the host device 1100 may transmit the query request for the 0-th node identifier NID_0 to the storage controller 1210.

In response to the query request, the storage controller 1210 may provide the memory device 1220 with the read command RD IND for reading the index data IND from the memory device 1220. The memory device 1220 may perform the read operation during a read time tRD in response to the read command RD IND. After the read operation, the memory device 1220 may transmit the index data IND to the storage controller 1210 (refer to “IND out” in FIG. 8B).

The storage controller 1210 may receive the index data IND from the memory device 1220 and may perform beam search (e.g., neighbor node search or distance calculation and nearest distance selection) by using the received index data IND. Afterwards, the storage controller 1220 may transmit the read command RD IND for reading the index data IND corresponding to the candidate nodes to the memory device 1220. The following operation is similar to that described above, and thus, additional description will be omitted to avoid redundancy.

According to the timing diagram of FIG. 8A, beam search is performed by the host device 1100. In this case, for one beam search, there is required an operation in which the index data IND are transmitted from the storage controller 1210 to the host device 1100. In contrast, according to the timing diagram of FIG. 8B, beam search is performed by storage controller 1210. In this case, for one beam search, there is not required an operation in which the index data IND are transmitted from the storage controller 1210 to the host device 1100. That is, because the operation of transmitting the index data IND from the storage controller 1210 to the host device 1100 is not performed, an operation time according to the transmission operation may be shortened. Accordingly, the entire time for beam search may be shortened. This means that the performance of the storage system 1000 is improved.

FIG. 9 is a block diagram illustrating a beam search circuit of FIG. 1, according to implementation of the present disclosure. Referring to FIGS. 1, 4, and 9, the beam search circuit 1211 may perform distance calculation and nearest distance selection based on the index data IND and may output node identifiers of k neighbor nodes.

For example, the beam search circuit 1211 may include a distance calculator, a top-L buffer, a beam circuit, a special function register (SFR), and a top-k selector (SEL top-k).

The distance calculator may calculate a distance d based on the vector data VD included in the index data IND and a vector value nbrV of a neighbor node. The calculated distance d may be transferred to the top-L buffer and the beam circuit. The top-L buffer may compare the calculate distance d and a stored distance and may store neighbor node identifiers nbrID corresponding to L top nearest distances.

The beam circuit may output a calculation signal Next_node for a next node based on the calculated distance d. The calculation signal Next_node for the next node is stored in the special function register. The information stored in the special function register may be provided to an RAM (e.g., refer to 1213 of FIG. 2), and the RAM 1213 may provide a neighbor node vector value corresponding to a next neighbor node to the distance calculator in response to the information stored in the special function register. After the above operation is iterated, the top-k selector may output neighbor node identifiers corresponding to k top nearest distances as the nearest distance node identifier NID.

The beam search circuit 1211 of FIG. 9 is provided as an example. The beam search circuit 1211 may be implemented in the storage controller 1210 through various forms, for example, software, hardware, firmware, or a combination of at least two thereof.

As described above, according to implementations of the present disclosure, the storage controller 1210 of the storage device 1200 may receive the query request for searching for k nodes near to the input node from the host device 1100. In response to the query request, the storage controller 1210 may repeatedly perform beam search by using index data corresponding to the input node and may transmit node identifiers NID of the k nodes to the host device 1100. In this case, because the index data IND used for beam search are not transmitted to the host device 1100, an operation time according to the transmission/reception of the index data IND may be shortened. In some examples, while the storage device 1200 performs the beam search, the index information is not transmitted to the host device.

FIG. 10 is a flowchart illustrating an example operation of a storage system of FIG. 1, according to some implementations of the present disclosure. Referring to FIGS. 1 and 10, in operation S210, the host device 1100 may transmit, to the storage device 1200, a write request for storing the index data IND in the storage device 1200. For example, the vector database VDB stored in the storage device 1200 may be managed by the host device 1100. For example, the vector data VD included in the vector database VDB may be embedded or structured by the host device 1100, and thus, the index information INDX may be generated or managed by the host device 1100. That is, when the index information INDX or the index data IND are generated or updated, the index information INDX or the index data IND may be stored in the storage device 1200 by the host device 1100.

In operation S220, the storage controller 1210 may generate replaced index data rIND by replacing a neighbor node identifier (e.g., nbrID) included in the index data IND with a physical address.

In operation S230, the storage controller 1210 may transmit a program command PGM for programming the replaced index data rIND in an area corresponding to a physical address PA to the memory device 1220. In some implementations, the physical address PA at which the replaced index data rIND are stored may correspond to a node identifier of the replaced index data rIND.

In operation S240, the memory device 1220 may store the replaced index data rIND in the area corresponding to the physical address PA.

In operation S250, the storage controller 1210 may receive information about program completion from the memory device 1220 and may transmit the information about program completion to the host device 1100,

In some implementations, a conventional storage device may perform address translation between a logical address and a physical address by using L2P mapping. That is, during the beam search operation of the storage controller 1210, when the read operation on a plurality of index data IND is repeatedly performed, physical addresses at which the plurality of index data IND are stored are identified through the FTL 1214. In this case, the address translation operation of the FTL 1214 may cause a time delay.

In contrast, according to the above implementation, the beam search circuit 1211 of the storage controller 1210 may perform beam search without passing through the FTL 1214. For example, the replaced index data rIND includes information about the physical address PA, instead of the neighbor node identifier nbrID. In this case, the physical address PA may indicate a physical location at which replaced index data corresponding to the neighbor node identifier nbrID are stored. In detail, it is assumed that the 0-th index data IND_0 includes the 01-th neighbor node identifier nbrID_01 and the 01-th neighbor vector value nbrV_01. In this case, the 01-th neighbor node identifier nbrID_01 may be replaced with a 01-th physical address PA01. That is, a 0-th replaced index data rIND_0 may include the 01-th physical address PA01 and the 01-th neighbor node vector value nbrV_01. In this case, replaced index data (e.g., rIND_0) corresponding to the 01-th neighbor node identifier nbrID_01 are stored in an area of the memory device 1220, which corresponds to the 01-th physical address PA01.

In this case, when the 01-th neighbor node vector value nbrV_01 is selected by the beam search circuit 1211 as corresponding to the nearest distance, the beam search circuit 1211 may read replaced index data (e.g., rIND_0), which correspond to the 01-th neighbor node identifier nbrID_01 stored at the 01-th physical address PA01, by using the 01-th physical address PA01 of the 0-th replaced index data rIND_0 and may continuously perform beam search based on the replaced index data (e.g., rIND_0). That is, because a physical address of replaced index data necessary for next beam search is checked based on the physical address at which the replaced index data rIND are stored, there is no need to pass through the FTL 1214 during the beam search operation.

FIG. 11 is a diagram for describing operation S220 of the flowchart of FIG. 10, according to some implementations of the present disclosure. Referring to FIGS. 1, 10, and 11, the host device 1100 may store the plurality of index data IND_0 to IND_n in the memory device 1220 of the storage device 1200.

In this case, the storage controller 1210 may generate replaced index data rIND_0 to rIND_n by replacing neighbor node identifiers nbrID_01 to nbrID_0m, nbrID_11 to nbrID_1r, etc. included in the plurality of index data IND_0 to IND_n with a plurality of physical addresses PA01 to PA0m, PA11 to PA1r, etc. The replaced index data rIND_0 to rIND_n may be stored in an area of the memory device 1220, which corresponds to a physical address.

For example, the 0-th index data IND_0 corresponding to the 0-th node identifier NID_0 may include the 0-th vector data VD0 corresponding to the 0-th node identifier NID_0, the number of neighbor nodes, denoted as “# of nbr”, the plurality of neighbor node identifiers nbrID_01 to nbrID_0m, and the plurality of neighbor node vector values nbrV_01 to nbrV_0m. The storage controller 1210 may generate the 0-th replaced index data rIND_0 by replacing the plurality of neighbor node identifiers nbrID_01 to nbrID_0m of the 0-th index data IND_0 with the plurality of physical addresses PA01 to PA0m. The 0-th replaced index data rIND_0 may be stored in an area of the memory device 1220, which corresponds to the 0-th physical address PA0. In some implementations, the 0-th physical address PA0 may be determined by replacing the 0-th node identifier NID_0.

In some implementations, the plurality of physical addresses PA01 to PA0m of the 0-th replaced index data rIND_0 may indicate locations at which replaced index data of neighbor nodes are respectively stored. For example, in the 0-th replaced index data rIND_0, the 01-th neighbor node identifier nbrID_01 is replaced with the 01-th physical address PA01. This means that replaced index data corresponding to the 01-th neighbor node identifier nbrID_01 are stored at the 01-th physical address PA01. That is, when it is determined that the 01-th neighbor vector value nbrV_01 corresponds to the nearest distance, the storage controller 1210 or the beam search circuit 1211 may read the replaced index data corresponding to the 01-th neighbor node identifier nbrID_01 from the memory device 1220 through the read operation on the 01-th physical address PA01 without passing through the FTL 1214.

FIG. 12 is a flowchart illustrating an operation of a storage system of FIG. 1, according to some implementations of the present disclosure. For convenience of description, additional description associated with the components described above will be omitted to avoid redundancy. Referring to FIGS. 1 and 12, in operation S310, the host device 1100 may transmit the query request including information about the 0-th node identifier NID_0 and “k” to the storage controller 1210. Operation S310 is similar to operation S110 of FIG. 6, and thus, additional description will be omitted to avoid redundancy.

In operation S321, the storage controller 1210 may transmit the read command for reading an a-th replaced index data rIND_a to the memory device 1220. In operation S322, the memory device 1220 may transmit the a-th replaced index data rIND_a to the storage controller 1220 in response to the read command.

In some implementations, when beam search corresponding to the 0-th node identifier NID_0 is performed (i.e., when beam search is first started), the storage controller 1210 may generate the 0-th physical address PA0 based on the 0-th node identifier NID_0 and may read replaced index data stored in an area corresponding to the 0-th physical address PA0. When a previously determined candidate node exists (i.e., when beam search is being performed), the storage controller 1210 may read replaced index data based on the physical address PA included in the replaced index data rIND.

In operation S323, the storage controller 1210 may perform beam search by using the replaced index data rIND. In operation S324, the storage controller 1210 may determine whether the search is done. Operation S323 and operation S324 are similar to operation S123 and operation S124 of FIG. 6, and thus, additional description will be omitted to avoid redundancy.

When the search is done, in operation S325, the storage controller 1210 may replace a physical address with a node identifier. For example, the storage controller 1210 may perform beam search, based on the replaced index data rIND. In this case, in association with the candidate nodes CND, instead of a node identifier, physical addresses corresponding to the candidate nodes CND may be stored in the beam search circuit 1211. Accordingly, the storage controller 1210 may replace the physical addresses PA corresponding to the candidate nodes CND with node identifiers.

Afterwards, the host device 1100, the storage controller 1210, and the memory device 1220 may perform operation S330 to operation S350.

As described above, the storage controller 1210 may perform beam search on the input node identifier NID_0 in response to the query request from the host device 1100. In this case, the storage controller 1210 may replace the neighbor node identifier nbrID stored in the index data IND with the physical address PA, so as to be stored in the memory device 1220. In this case, the physical address PA may indicate an area corresponding to the physical address PA at which the index data IND corresponding to the neighbor node identifier nbrID are stored. In other words, the index data IND corresponding to the neighbor node identifier nbrID may be directly stored in the memory device 1220. In this case, when beam search is repeatedly performed by the storage controller 1210 or the beam search circuit 1211, the intervention of the FTL for determining a storage location of index data may not be required, and thus, a beam search speed may be improved.

In the above implementation, the FTL 1214 may not be intervened in the process of reading index data during the beam search, but address translation may be performed by the FTL 1214 during an operation of converting the index data into replaced index data, an operation of translating a neighbor node identifier into a physical address, or an operation of writing the index data in the memory device 1220.

FIG. 13 is a diagram for describing an operation based on the flowchart of FIG. 12, according to some implementations of the present disclosure. For convenience of description, components which are unnecessary to describe an operation based on the flowchart of FIG. 12 are omitted. Referring to FIGS. 1, 12, and 13, the 0-th replaced index data rIND_0 may include the 0-th vector data VD0, the number of neighbor nodes, denoted as “# of nbr”, the plurality of physical addresses PA01 to PA0m, and the plurality of neighbor node vector values nbrV_01 to nbrV_0m.

The beam search circuit 1211 of the storage controller 1210 may perform distance calculation and nearest distance selection based on the 0-th replaced index data rIND_0. For example, as in the above description given with reference to FIG. 7B, the storage controller 1210 may calculate the 01-th distance d01 between the 0-th vector data VD0 and the 01-th neighbor node vector value nbrV_01, the 02-th distance d02 between the 0-th vector data VD0 and the 02-th neighbor node vector value nbrV_02, and the 0m-th distance d0m between the 0-th vector data VD0 and the 0m-th neighbor node vector value nbrV_0m.

The 01-th distance d01 and the 02-th distance d02 among the plurality of distances d01 to d0m may be selected by the beam search circuit 1211 as the nearest distance. Accordingly, the beam search circuit 1211 may continuously perform beam search on a 01-th neighbor node corresponding to the 01-th neighbor node vector value nbrV_01 and a 02-th neighbor node corresponding to the 02-th neighbor node vector value nbrV_02. To this end, the beam search circuit 1211 may read the 01-th and 02-th replaced index data rIND_01 and rIND_02 corresponding to the 01-th and 02-th neighbor nodes from the memory device 1220.

In this case, the beam search circuit 1211 may read the 01-th replaced index data rIND_01 from the memory device 1220 by using the 01-th physical address PA01 of the 0-th replaced index data rIND_0, which corresponds to the 01-th neighbor node vector value nbrV_01. The beam search circuit 1211 may read the 02-th replaced index data rIND_02 from the memory device 1220 by using the 02-th physical address PA02 of the 0-th replaced index data rIND_0, which corresponds to the 02-th neighbor node vector value nbr02_V. That is, in the case of repeatedly reading index data, the beam search circuit 1211 may read the index data by using a physical address included in the replaced index data rIND without intervention of the FTL 1214.

FIG. 14 is a flowchart illustrating an operation of a storage system of FIG. 1, according to some implementations of the present disclosure. Referring to FIGS. 1 and 14, in operation S410, the host device 1100 may transmit, to the storage device 1200, the write request for storing the index data IND in the storage device 1200. Operation S410 is similar to operation S210 of FIG. 10, and thus, additional description will be omitted to avoid redundancy.

In operation S420, the storage controller 1210 may replicate the index data IND. For example, the memory device 1220 may include a plurality of memories configured to communicate with the storage controller 1210 through a plurality of channels. Memories connected to different channels may operate independently of each other. The storage controller 1210 may replicate the index data IND such that the same index data IND are stored in the plurality of memories connected to the plurality of channels.

In operation S430, the storage controller 1210 may transmit the program command for storing the index data IND in the plurality of memories to the memory device 1220. In some implementations, the program command may be transmitted to each of the plurality of memories connected to the plurality of channels.

In operation S440, the memory device 1220 may program the index data IND in memories of each channel. Afterwards, in operation S450, the storage controller 1210 may receive information about program completion from the memory device 1220 and may transmit the information about program completion to the host device 1100.

FIG. 15 is a diagram for describing an operation based on the flowchart of FIG. 14, according to some implementations of the present disclosure. Referring to FIGS. 1, 14, and 15, the storage device 1000 may include the host device 1100 and the storage device 1200. The storage device 1200 may include the storage controller 1210 and the memory device 1220. The memory device 1220 may include a plurality of memories 1221 to 1224. The storage controller 1210 may individually communicate with the plurality of memories 1221 to 1224 through a plurality of channels CH1 to CH4.

To store the index data IND in the storage device 1200 (or the memory device 1220), the host device 1100 may transmit a write request RQ_WR to the storage device 1210. The storage controller 1210 may replicate the index data IND in response to the write request RQ_WR. The replicated index data IND may be stored in each of the plurality of memories 1221 to 1224 through the plurality of channels CH1 to CH4.

For example, the host device 1100 may issue the write request for the 0-th index data IND0. In this case, the storage controller 1210 may transmit the 0-th index data to the first memory 1221 through the first channel CH1, may transmit the 0-th index data to the second memory 1222 through the second channel CH2, may transmit the 0-th index data to the third memory 1223 through the third channel CH3, and may transmit the 0-th index data to the fourth memory 1224 through the fourth channel CH4. Each of the first to fourth memories 1221 to 1224 may store the 0-th index data thus received. In other words, the 0-th index data may be stored in each of the first to fourth memories 1221 to 1224.

In some implementations, the first to fourth memories 1221 to 1224 respectively connected to the first to fourth channels CH1 to CH4 may operate independently of each other. That is, the operations in which the replicated index data are transmitted to the first to fourth memories 1221 to 1224 through the first to fourth channels CH1 to CH4 may be performed simultaneously or in parallel. The operations in which the replicated index data are programmed in the first to fourth memories 1221 to 1224 may be performed simultaneously or in parallel.

In some implementations, the same index data may be stored in areas of the first to fourth memories 1221 to 1224, which correspond to the same physical address. For example, first index data may be stored in areas of the first to fourth memories 1221 to 1224, which correspond to a first physical address. That is, when read operations on the first physical address are respectively performed in the first to fourth memories 1221 to 1224, the first index data may be read from each of the first to fourth memories 1221 to 1224.

FIG. 16 is a flowchart illustrating a storage system of FIG. 1, according to some implementations of the present disclosure. For convenience of description, additional description associated with the components described above will be omitted to avoid redundancy. In operation S510, the host device 1100 may transmit the query request including information about the 0-th node identifier NID_0 and “k” to the storage controller 1210. Operation S510 is similar to operation S110 of FIG. 6, and thus, additional description will be omitted to avoid redundancy.

In operation S521, the storage controller 1210 may transmit the read command for reading the a-th index data IND_a to the memory device 1220. In operation S522, the memory device 1220 may transmit the a-th index data IND_a to the storage controller 1210 in response to the read command. In operation S523, the storage controller 1210 may perform beam search by using the a-th index data IND_a. In operation S524, the storage controller 1210 may determine whether the search is done. Operation S521 to operation S524 are similar to operation S121 to operation S124 of FIG. 6, and thus, additional description will be omitted to avoid redundancy.

In some implementations, to perform beam search, the beam search circuit 1211 of the storage controller 1210 may require a plurality of index data. In this case, in operation S521, the storage controller 1210 may read a plurality of index data in parallel from a plurality of memories connected to a plurality of channels. For example, as described with reference to FIGS. 14 and 15, it is assumed that the plurality of memories 1221 to 1224 may be in a state where the first to fourth index data are respectively stored therein and the first to fourth index data are required for beam search. In this case, the storage controller 1210 may read the first index data from the first memory 1221 connected to the first channel CH1, may read the second index data from the second memory 1222 connected to the second channel CH2, may read the third index data from the third memory 1223 connected to the third channel CH3, and may read the fourth index data from the fourth memory 1224 connected to the fourth channel CH4. This may mean that the first to fourth index data are read simultaneously or in parallel from the plurality of memories 1221 to 1224 through the plurality of channels CH1 to CH4. Accordingly, a time necessary to read the index data may decrease.

Afterwards, the host device 1100, the storage controller 1210, and the memory device 1220 may perform operation S530 to operation S550. Operation S530 to operation S550 are similar to operation S130 to operation S150 of FIG. 6, and thus, additional description will be omitted to avoid redundancy.

FIG. 17 is a diagram for describing an operation based on the flowchart of FIG. 16, according to some implementations of the present disclosure. Referring to FIGS. 1, 16, and 17, the storage controller 1210 may perform beam search in response to the query request of the host device 1100. During the beam search, the first to fourth node identifiers NID_1 to NID_4 may be selected as the candidate node CND.

To continuously perform the beam search, the storage controller 1210 may read the first to fourth index data IND_1 to IND_4 corresponding to the first to fourth node identifiers NID_1 to NID_4 from the memory device 1220. In this case, the storage controller 1210 may read the first to fourth index data IND_1 to IND_4 from the first to fourth memories 121 to 1224 of the memory device 1220. For example, the first to fourth memories 1221 to 1224 of the memory device 1220 may store the first to fourth index data IND_1 to IND_4, respectively. The storage controller 1210 may read the first index data IND_1 from the first memory 1221 through the first channel CH1, may read the second index data IND_2 from the second memory 1222 through the second channel CH2, may read the third index IND_3 from the third memory 1223 through the third channel CH3, and may read the fourth index data IND_4 from the fourth memory 1224 through the fourth channel CH4. In this case, because the first to fourth index data IND_1 to IND_4 are read simultaneously or in parallel from the first to fourth memories 1221 to 1224, a time necessary to read the index data may be shortened.

FIG. 18 is a flowchart illustrating a storage system of FIG. 1, according to some implementations of the present disclosure. Referring to FIGS. 1 and 18, in operation S610, the host device 1100 may transmit a query request including information about the 0-th node identifier NID_0 and “k” to the storage controller 1210. In operation S621, the storage controller 1210 may transmit the read command for reading the a-th index data IND_a to the memory device 1220. In operation S622, the memory device 1220 may transmit the a-th index data IND_a to the storage controller 1210. In operation S623, the storage controller 1210 may perform beam search by using the a-th index data IND_a. In operation S624, the storage controller 1210 may determine whether the beam search is done. Operation S610 to operation S624 are similar to operation S110 to operation S124 of FIG. 6, and thus, additional description will be omitted to avoid redundancy.

In operation S630, the storage controller 1210 may determine target vector data, based on k neighbor node identifiers. For example, the storage controller 1210 may be configured to execute the artificial intelligence model implemented by the host device 1100. In this case, the storage controller 1210 may determine the target vector data, based on the k neighbor node identifiers determined through the beam search.

In operation S641, the storage controller 1210 may transmit the read command for reading the target vector data VD_t to the memory device 1220. In operation S642, the memory device 1220 may transmit the target vector data VD_t to the storage controller 1210 in response to the read command. In operation S643, the storage controller 1210 may transmit the target vector data VD_t to the host device 1100.

As described above, according to some implementations of the present disclosure, the storage controller 1210 may perform beam search on the input node in response to the query request of the host device 1100. The storage controller 1210 may provide the k neighbor node identifiers to the host device 1100 as a beam search result. In this case, because an operation in which the index data are repeatedly transmitted to the host device 1100 is omitted, the performance of the storage system 1000 may be improved.

In some implementations, the storage controller 1210 may execute at least portion of the artificial intelligence model implemented by the host device 1100; in this case, the storage controller 1210 may perform beam search in response to the query request of the host device 1100 and may transmit the target vector data to the host device 1100 as a beam search result.

The above implementations may be carried out individually, or at least two of the above implementations may be combined.

FIG. 19 is a diagram of a data center 3000 to which a storage device is applied, according to some implementations.

Referring to FIG. 19, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to implementations. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some implementations, the numbers of processors 3210 and memories 3220 included in the storage server 3200 may be variously selected. In some implementations, the processor 3210 and the memory 3220 may provide a processor-memory pair. In some implementations, the number of processors 3210 may be different from the number of memories 3220. The processor 3210 may include a single-core processor or a multi-core processor. The above description of the storage server 3200 may be similarly applied to the application server 3100. In some implementations, the application server 3100 may not include a storage device 3150. The storage server 3200 may include at least one storage device 3250. The number of storage devices 3250 included in the storage server 3200 may be variously selected according to implementations.

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In some implementations, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another implementation, the network 3300 may be a general network, such as a TCP/IP network. For example, the network 3300 may be implemented according to a protocol, such as FC over Ethernet (FCoE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC(Network InterConnect) 3240. The switch 3230 may selectively connect the processor 3210 to the storage device 3250 or selectively connect the NIC 3240 to the storage device 3250 via the control of the processor 3210.

In some implementations, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In some implementations, the NIC 3240 may be integrated with at least one of the processor 3210, the switch 3230, and the storage device 3250.

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

The controller 3251 may control all operations of the storage device 3250. In some implementations, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

According to the present disclosure, a storage device may perform beam search on a vector database depending on a request of a host device. In this case, because an operation in which index data of the vector database are repeatedly transmitted to the host device is not performed, a speed at which beam search on the vector database is performed may be improved. Accordingly, a storage device with improved performance, a storage system, and an operation method of the storage device are provided.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been described with reference to implementations thereof, it will be apparent to those of ordinary skill in the art that various changes and modifications may be made thereto without departing from the spirit and scope of the present disclosure as set forth in the following claims.

What is claimed is:

1. A storage device comprising:
a memory device configured to store a vector database comprising (i) a plurality of vector data and (ii) index information data; and
a storage controller configured to control the memory device,
wherein the storage controller is configured to:
receive, from a host device, a query request comprising a start node identifier;
perform, based on receiving the query request, a beam search on the start node identifier based on the index information data; and
transmit, to the host device, a response comprising at least one neighbor node identifier corresponding to the start node identifier.

2. The storage device of claim 1, wherein the query request comprises information related to a natural number that is indicative of a number of the at least one neighbor node identifier.

3. The storage device of claim 1, wherein the storage controller is configured to:
determine, based on the index information data, a respective distance between (i) a start node corresponding to the start node identifier and (ii) each of a plurality of neighbor nodes; and
determine, among the plurality of neighbor nodes, at least one candidate node based on the respective distance.

4. The storage device of claim 1, wherein the index information data comprises a plurality of index data, and
wherein each of the plurality of index data comprises (i) information regarding a number of a plurality of neighbor nodes associated with a node corresponding to respective vector data of the plurality of vector data, (ii) a plurality of neighbor node identifiers corresponding to respective vector data of the plurality of vector data, and (iii) a plurality of neighbor node vector values corresponding to respective vector data of the plurality of vector data.

5. The storage device of claim 4, wherein the storage controller is configured to:
read, among the plurality of index data, 0-th index data corresponding to the start node from the memory device; and
determine, based on reading the 0-th index data, a respective distance between the start node and each of the plurality of neighbor nodes.

6. The storage device of claim 5, wherein the 0-th index data is not transmitted to the host device.

7. The storage device of claim 4, wherein the storage controller is configured to:
read, among the plurality of index data, index data corresponding to at least one candidate node from the memory device; and
determine, based on respective index data corresponding to the at least one candidate node, a respective distance between the at least one candidate node and each of a plurality of neighbor nodes.

8. The storage device of claim 1, wherein the index information data includes a plurality of index data, and
wherein each of the plurality of index data comprises (i) information regarding a number of a plurality of neighbor nodes associated with a node corresponding to respective vector data of the plurality of vector data, (ii) a plurality of physical address corresponding to the respective vector data of the plurality of vector data, and (iii) a plurality of neighbor node vector values corresponding to respective vector data of the plurality of vector data.

9. The storage device of claim 8, wherein the plurality of index data, each index data corresponding to a respective vector value of the plurality of neighbor node vector values, are stored in areas of the memory device, wherein the areas correspond to the plurality of physical addresses.

10. The storage device of claim 1, wherein the memory device includes a plurality of memories, and
wherein the plurality of memories communicate with the storage controller through a plurality of channels, respectively.

11. The storage device of claim 10, wherein each of the plurality of memories is configured to store the index information data.

12. The storage device of claim 1, wherein the storage controller includes:
a beam search circuit configured to perform the beam search.

13. A method of operating a storage device comprising:
receiving, from a host device, a query request comprising a start node identifier,
performing, in response to the query request, beam search on the start node identifier based on index information data included in a vector database to determine a plurality of neighbor nodes corresponding to the start node identifier; and
transmitting, to the host device a response to the query request, the response including neighbor node identifiers corresponding to the neighbor nodes.

14. The method of claim 13, wherein the index information data comprises a plurality of index data, and
wherein performing the beam search on the start node identifier comprises:
determining, based on index data corresponding to the start node identifier among the plurality of index data, a respective distance between (i) a start node corresponding to the start node identifier and (ii) each of the plurality of neighbor nodes, and
determining one or more candidate nodes based on the respective distance.

15. The method of claim 14, wherein the index data corresponding to the start node identifier is not transmitted to the host device.

16. The method of claim 13, comprising:
receiving, from the host device, a write request for writing first index data;
generating, based on receiving the write request, first replaced index data based on replacing a plurality of neighbor node identifiers included in the first index data with a plurality of physical addresses; and
storing the first replaced index data in a memory device of the storage device based on a first physical address corresponding to a first node identifier of the first index data.

17. The method of claim 13, wherein the storage device comprises:
a storage controller; and
a memory device comprising a plurality of memories connected to the storage controller through a plurality of channels, respectively,
wherein the method comprises:
receiving a write request for writing first index data from the host device; and
storing the first index data in each of the plurality of memories based on receiving the write request.

18. A storage system comprising:
a host device configured to perform an artificial intelligence operation; and
a storage device configured to store a vector database comprising a plurality of vector data and index information data,
wherein the storage device is configured to:
receive a query request comprising a start node identifier from the host device,
perform, based on receiving the query request, a beam search on the start node identifier based on the index information data, and
transmit, to the host device, a response comprising at least one neighbor node identifier corresponding to the start node identifier, and
wherein the host device is configured to, based on performing artificial intelligence operation utilizing the at least one neighbor node identifier, determine target vector data.

19. The storage system of claim 18, wherein, while the storage device performs the beam search, the index information data is not transmitted to the host device.

20. The storage system of claim 18, wherein the host device transmits, to the storage device, a read request including a target logical address corresponding to the target vector data, and
wherein the storage device transmits, based on receiving the read request, the target vector data among the plurality of vector data to the host device.
